(19) United States
(12) Patent Application Publication
(10) Pub. No.: US 2025/0385838 A1
(43) Pub. Date: Dec. 18, 2025

(54) RAN INTELLIGENT CONTROLLER (RIC) AND METHOD THEREFOR

(71) Applicant: NEC Corporation, Minato-ku, Tokyo (JP)

(72) Inventors: Katsunori DATE, Tokyo (JP); Masayuki UEDA, Tokyo (JP); Kenji KAWAGUCHI, Tokyo (JP); Yoshinori WATANABE, Tokyo (JP); Hideki KOZUKA, Tokyo (JP); Rumi MATSUMURA, Tokyo (JP); Eiji TAKAHASHI, Tokyo (JP); Takeo ONISHI, Tokyo (JP)

(73) Assignee: NEC Corporation, Minato-ku, Tokyo (JP)

(21) Appl. No.: 18/878,144

(22) PCT Filed: Aug. 2, 2023
(86) PCT No.: PCT/JP2023/028217

§ 371 Date: Dec. 23, 2024

(30) Foreign Application Priority Data
Aug. 12, 2022 (JP) 2022-128678

(51) Int. Cl. H04L 41/0894; H04W 24/02

(52) U.S. Cl. CPC H04L 41/0894; H04W 24/02

(57) ABSTRACT

A first Radio Access Network (RAN) Intelligent Controller (RIC) (1) receives, in a single message, from a second RIC (3) located between the first RIC (1) and one or more RAN nodes (4), feedback regarding an enforcement status of a plurality of policies, each including one or more policy statements. For example, this can help to reduce the amount of traffic or number of transactions required to provide feedback regarding the enforcement status of a plurality of policies, each including one or more policy statements.

### TECHNICAL FIELD

The present disclosure relates to interfaces between logical functions, controllers, or systems for controlling and optimizing a radio access network.

### BACKGROUND ART

The Open Radio Access Network (O-RAN) Alliance is a community of mobile operators, vendors, and research and academic institutions, and its mission is to re-shape radio access networks (RANs) to be more intelligent, open, virtualized and fully interoperable. The O-RAN Working Group 2 (WG2) has conducted technical studies and provided technical specifications for the Non-Real-Time (Non-RT) RAN Intelligent Controller (RIC) and the A1 interface (see, for example, Non-Patent Literature 1-5).

A Non-RT RIC is a logical function within a Service Management and Orchestration (SMO) framework. The SMO framework can be referred to simply as SMO. The Non-RT RIC consists of a Non-RT RIC framework and Non-RT RIC applications (rApps). The Non-RT RIC framework includes functionality to logically terminate A1 interfaces and expose a set of R1 services to rApps. The A1 termination allows the Non-RT RIC framework and a Near-RT RIC to exchange messages on an A1 interface. The set of R1 services includes, among others, A1-related services and O1-related services. A1-related services include, among others, creating, updating, querying, and deleting A1 policies; querying the enforcement status of A1 policies; and subscribing to event notifications about A1 policies, including notifications of changes in the enforcement status of A1 policies.

O1-related services are provided by one or both of the SMO framework and the Non-RT RIC framework. O1-related services allow rApps to obtain information about alarms, obtain performance information related to the network, obtain the current configuration of the network, provision changes to the network configuration, and obtain additional information related to the network.

The SMO framework provides various logical functions that are not anchored in the Non-RT RIC. These logical functions include, but are not limited to, O1 termination, O2 termination, and external terminations. The O1 termination allows the SMO framework to exchange messages with the Near-RT RIC and E2 Nodes on O1 interfaces.

The Near-RT RIC is a logical function that enables near real-time control and optimization of RAN elements and resources through fine-grained data collection and actions on E2 interfaces. The Near-RT RIC hosts a set of applications called xApps and provides a set of platform functions that are commonly used to support specific functions hosted by xApps. The set of platform functions includes interface terminations and other functions. The interface terminations include E2, A1, and O1 terminations, which provide E2 interface termination, A1 interface termination, and O1 interface termination, respectively.

An E2 interface connects the Near-RT RIC to one or more E2 Nodes. An E2 Node is a logical node that terminates an E2 interface. An E2 Node is a RAN node that exposes one or more RAN functions to the Near-RT RIC and hosted xApps. For NR access, E2 Nodes include one or more O-RAN Central Units-Control Plane (O-CU-CPs), one or more O-RAN Central Units-User Plane (O-CU-UPs), one or more O-RAN Distributed Units (O-DUs), or any combination thereof. On the other hand, for Evolved Universal Terrestrial Radio Access (E-UTRA) access, E2 Nodes include one or more O-RAN eNodeBs (O-eNBs).

The following describes A1 policy management on the A1 interface. The Non-RT RIC defines A1 policies to be provided to the Near-RT RIC via the A1 interface. A1 policies are declarative policies that contain statements about policy objectives and policy resources applicable to UEs and cells. The purpose of A1 policies is to guide the RAN performance towards the overall goal expressed in RAN Intent. In other words, the purpose of A1 policies is to allow the Non-RT RIC function of the SMO to guide the Near-RT RIC function, and hence the RAN, to better meet the RAN Intent. The RAN Intent is an expression of high-level operational or business goals to be achieved by the RAN, allowing an operator to specify desired Service Level Agreements (SLAs) that the RAN needs to fulfill for all or a class of users in a given area over a given period of time.

The Non-RT RIC manages A1 policies based on A1 policy feedback and on a network status provided over O1. The Non-RT RIC uses the O1 observables to continuously evaluate the impact of the A1 policies on the fulfillment of the RAN Intent and decides, based on internal conditions, to issue or update the goals expressed in the A1 policies. The Near-RT RIC functions based on its internal functions or applications, the configuration received over O1, and the temporary A1 policies received over A1.

An A1 policy type is identified by a policy type identifier (PolicyTypeId). Different policy types have different Policy TypeIds. Based on the PolicyTypeId, schemas are identified and used for creation, validation and formulation, and for query of the status, of A1 policies of that type.

An A1 policy is identified by a policy identifier (PolicyId) that is assigned by the Non-RT RIC. The PolicyId is locally unique within the Non-RT RIC and is sent in policy request operations that carry representations of A1 policies.

An A1 policy consists of a scope identifier and one or more policy statements. The scope identifier represents what the policy statements are to be applied on (e.g., UEs, QoS flows, or cells). The policy statements represent the goals to the Near-RT RIC and covers policy objectives and policy resources.

More specifically, an A1 policy is identified by a policy identifier (policyId) and is represented as a JavaScript Object Notation (JSON) object called a policy object (PolicyObject). A policy object contains a single scope identifier and at least one policy statement. At least one policy statement may include one or more policy objective statements and/or one or more policy resource statements. The policy identifier (policyId) is assigned by the A1 Policy Management Service (A1-P) Consumer, i.e., the Non-RT RIC, when the policy is created. Policy feedback for a specific A1 policy is subscribed to when the policy is created by providing a callback Uniform Resource Identifier (URI).

Identifiers that can be used as scope identifiers in an A1 policy are defined as data types in Non-Patent Literature 5 (A1 Type Definitions Specification). A scope identifier may consist of any or a combination of these data types, as described in more detail in the policy type definitions in Non-Patent Literature 5. Specifically, a scope identifier may be a UE identifier (Ueid), a UE group identifier (GroupId), a slice identifier (SliceId), a QoS identifier (QosId), a cell identifier (CellId), or any combination thereof.

A1 Policy creation and enforcement is performed on a per-policy basis. Accordingly, multiple A1 policies are created by repeating the operation of creating a single A1 policy. The operation of creating a single A1 policy is based on an HTTP PUT. The A1 policy to be created is identified by a URI containing policyId in the request line of the PUT request. The message body of the PUT request contains the Policy Object. The steps to create a single A1 policy are as follows. The A1-P Consumer (i.e., the Non-RT RIC) generates a policyId and sends an HTTP PUT request to the A1-P Producer (i.e., the Near-RT RIC). The target URI identifies the resource (policyId) under which the new policy shall be created. The message body carries a Policy Object. The A1-P Producer returns an HTTP PUT response. On success, “201 Created” is returned, the location header carries the URI of the new policy, and the message body carries the Policy Object. On failure, the appropriate error code is returned, and the message body may contain additional error information. The A1-P Consumer can request policy status updates for the created policy by including the notificationDestination as a query parameter in the PUT request. This is related to the feedback policy operation described below.

The operation of querying the enforcement status of a single A1 policy is based on HTTP GET. The A1 policy for which the status is to be read is identified by a URI containing policyId, while the message body is empty. The response by the A1-P Producer returns a policy status object (PolicyStatusObject). The Policy StatusObject indicates the enforcement status of the A1 policy and, if the enforcement status is NOT ENFORCED, other brief information about the cause of the non-enforcement.

As with A1 policy creation, A1 policy updates are performed on a per-policy basis. Accordingly, multiple A1 policies are updated by repeating the operation of updating a single A1 policy. The operation of updating a single A1 policy is based on an HTTP PUT. The A1 policy to be updated is identified by a URI containing policyId in the request line of the PUT request. The message body of the PUT request contains the Policy Object of the policy being updated.

Feedback policy is an operation that requires the A1-P Producer (i.e., the Near-RT RIC) to have a reduced feature HTTP Client for sending HTTP POST requests and receiving HTTP POST responses. Correspondingly, the A1-P Consumer (i.e., the Non-RT RIC) is required to have a reduced feature HTTP Server for receiving HTTP POST requests and sending HTTP POST responses. The A1-P Producer uses the Feedback policy operation to notify the A1-P Consumer about changes in the policy enforcement status for an A1 policy. The operation to provide policy feedback is based on HTTP POST. The URI in the request line of the POST request contains the target resource for policy notification handling. In other words, a policy feedback notification is sent to the URI for notification handling. The notification content is represented in a Policy StatusObject that is included in the message body of the POST request. The Policy StatusObject contains information about policy enforcement status changes and their causes. This procedure is used to notify about an enforcement status change of a policy between “enforced” and “not enforced”.

According to Non-Patent Literature 5 (A1 Type Definitions Specification), the policy status object (Policy StatusObject) shall include an enforceStatus attribute. The enforceStatus attribute indicates the enforcement status of the A1 policy. The enforceStatus attribute is an enumeration (or enumerated) type that indicates ENFORCED or NOT_ENFORCED. ENFORCED indicates that the policy is enforced; NOT_ENFORCED indicates that the policy is not enforced. In addition, when the enforceStatus attribute is NOT_ENFORCED, the Policy StatusObject contains an enforceReason attribute. The enforceReason attribute indicates a short reason for the change in enforcement status (or a brief reason for sending the notification). The enforceReason attribute is an enumerated type that indicates SCOPE_NOT_APPLICABLE, STATEMENT_NOT_APPLICABLE, or OTHER_REASON. SCOPE_NOT_APPLICABLE indicates that the scope provided can no longer be applied to enforce the policy.

STATEMENT_NOT_APPLICABLE indicates that the policy statement(s) cannot be applied due to other changes. OTHER_REASON is set to the enforceReason attribute when the policy can no longer be enforced for reasons other than the scope or the statement becoming inapplicable.

### CITATION LIST

### Non Patent Literature

[Non-Patent Literature 1] O-RAN ALLIANCE Working Group 2, “O-RAN Non-RT RIC Architecture 2.0”, O-RAN. WG2. Non-RT-RIC-ARCH-TS-v02.00, July 2022

[Non-Patent Literature 2] O-RAN ALLIANCE Working Group 2, “O-RAN Non-RT RIC & A1 Interface: Use Cases and Requirements 6.0”, O-RAN.WG2. Use-Case-Requirements-v06.00, July 2022

[Non-Patent Literature 3] O-RAN ALLIANCE Working Group 2, “O-RAN A 1 interface: General Aspects and Principles 2.03”, O-RAN.WG2.A1GAP-v02.03, October 2021

[Non-Patent Literature 4] O-RAN ALLIANCE Working Group 2, “O-RAN A1 interface: Application Protocol 3.O2”, O-RAN. WG2. A1AP-v03.O2, July 2022

[Non-Patent Literature 5] O-RAN ALLIANCE Working Group 2, “O-RAN A1 interface: Type Definitions 3.0”, O-RAN.WG2. A1TD-v03.00, July 2022

### SUMMARY OF INVENTION

### Technical Problem

The inventors have studied the operations, procedures, and signaling over the A1 interface for A1 policy management and found problems. One of these problems relates to feedback of the enforcement status of A1 policies. Specifically, it is desirable to reduce the traffic on the A1 interface between the Non-RT RIC and the Near-RT RIC, especially the number of HTTP transactions, required to provide feedback on the enforcement status of multiple A1 policies. As described above, according to the current O-RAN WG2 technical specifications, policy feedback is an HTTP POST request sent on a per-policy basis. That is, policy feedback is sent per A1 policy. In other words, policy feedback is sent per policy identifier, per scope identifier, or per policy object. Consequently, the amount of policy feedback traffic may increase if, for example, a large number of A1 policies are created and enforced per UE. Specifically, a large number of HTTP transactions would occur for multiple policy feedbacks for multiple A1 policies whose enforcement status has changed.

As an example, consider the case where multiple scope identifiers of multiple A1 policies have specified different UE identifiers in a cell, but the policy statements of these multiple A1 policies become inapplicable at the same time. In this case, the Near-RT RIC will need to perform multiple feedback policy operations or procedures corresponding to the multiple A1 policies to send multiple policy feedbacks. As another example, consider the case where each of multiple scope identifiers of multiple A1 policies has specified the same UE identifier along with one or more other identifiers (e.g., slice identifier or QoS identifier), but a change in this UE identifier renders all of the multiple A1 policies unenforceable. Even in this case, the Near-RT RIC will need to perform multiple feedback policy operations or procedures corresponding to the multiple A1 policies to send multiple policy feedback.

Another problem identified by the inventors relates to the creation of A1 policies. Specifically, it is desirable to be able to reduce the traffic on the A1 interface between the Non-RT RIC and the Near-RT RIC, especially the number of HTTP transactions, required to create multiple A1 policies. As described above, according to the current O-RAN WG2 technical specifications, the A1 policy creation operation is performed per A1 policy. For example, if an A1 policy is created for each UE of multiple UEs, the amount of policy creation traffic increases. In other words, a large number of HTTP transactions would be required to create multiple A1 policies.

Still another problem identified by the inventors relates to the provision of more detailed information about the unenforceability of an A1 policy over the A1 interface. According to the current O-RAN WG2 technical specifications, when the policy enforcement status changes from “enforced” to “not enforced”, the Near-RT RIC can send an HTTP POST request message containing a policy status object (Policy StatusObject) in its message body to the Non-RT RIC for policy feedback. In addition, according to the current O-RAN WG2 technical specifications, the Non-RT RIC can send an HTTP GET request message to the Near-RT RIC to query the Near-RT RIC about the policy status, i.e., the enforcement status of the A1 policy. In response, the Near-RT RIC can send an HTTP GET response message containing the Policy StatusObject in its message body to the Non-RT RIC.

However, even though the Policy StatusObject contains the enforceReason attribute when the enforceStatus attribute is NOT_ENFORCED, the enforceReason attribute can only indicate “SCOPE_NOT_APPLICABLE”, “STATEMENT_NOT_APPLICABLE”, or “OTHER_REASON”. Therefore, after the Non-RT RIC receives a feedback or query response from the Near-RT RIC with the Policy StatusObject indicating that the enforceStatus attribute is “NOT_ENFORCED”, the Non-RT RIC needs to collect detailed information from the E2 Node or the Near-RT RIC via the O1 interface. In general, information retrieval via the O1 interface requires a longer response time than information retrieval via the A1 interface. Thus, there would be a long delay between the time the Non-RT RIC becomes aware of the non-enforcement of an A1 policy and the time it updates and (re)enforces that A1 policy based on the information obtained through the O1 interface. This may make it difficult, for example, to dynamically update A1 policies to reflect sudden changes in the wireless environment.

As an example, consider the case where, after an A1 policy has been created with a scope identifier that includes a UE identifier, the Non-RT RIC receives a feedback or query response from the Near-RT RIC indicating that the A1 policy was not enforced and the cause is “SCOPE NOT APPLICABLE”. In this case, the Non-RT RIC may be able to estimate that the UE identifier has changed. However, the Non-RT RIC cannot know the new value of the UE identifier after the change via the feedback or query response on the A1 interface or other A1 policy management related procedures. Therefore, the Non-RT RIC needs to query the E2 Node or the Near-RT RIC via the O1 interface for the value of the changed UE identifier.

As another example, consider the case where the Non-RT RIC receives a feedback or query response from the Near-RT RIC indicating that an A1 policy is not enforced and the cause is “STATEMENT NOT APPLICABLE”. In this case, there is no way for the Non-RT RIC to know which of the multiple policy statements is inapplicable through the feedback or query response on the A1 interface or other A1 policy management related procedures. Similarly, there is no way for the Non-RT RIC to know which specific reason a policy statement is inapplicable through the feedback or query response on the A1 interface or other A1 policy management related procedures. Therefore, the Non-RT RIC needs to query the Near-RT RIC or the E2 Node for these details through the O1 interface.

One of the objects to be achieved by the example embodiments disclosed herein is to provide apparatus, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### Solution to Problem

In a first aspect, a first RIC includes at least one memory and at least one processor coupled to the at least one memory. The at least one processor is configured to receive, in a single message, from a second RIC located between the first RIC and one or more RAN nodes, feedback regarding an enforcement status of a plurality of policies, each including one or more policy statements.

In a second aspect, a method performed by a first RIC includes receiving, in a single message, from a second RIC located between the first RIC and one or more RAN nodes, feedback regarding an enforcement status of a plurality of policies, each including one or more policy statements.

A third aspect is directed to a second RIC to be deployed between a first RIC and one or more RAN nodes. The second RIC includes at least one memory and at least one processor coupled to the at least one memory. The at least one processor is configured to send, in a single message to the first RIC, feedback regarding an enforcement status of a plurality of policies, each including one or more policy statements.

A fourth aspect is directed to a method performed by a second RIC to be deployed between a first RIC and one or more RAN nodes. The method includes sending, in a single message to the first RIC, feedback regarding an enforcement status of a plurality of policies, each including one or more policy statements.

In a fifth aspect, a first RIC includes at least one memory and at least one processor coupled to the at least one memory. The at least one processor is configured to send, in a single request message, to a second RIC located between the first RIC and one or more RAN nodes, a request to create a plurality of policies, each including one or more policy statements.

In a sixth aspect, a method performed by a first RIC includes sending, in a single request message, to a second RIC located between the first RIC and one or more RAN nodes, a request to create a plurality of policies, each including one or more policy statements.

A seventh aspect is directed to a second RIC to be deployed between a first RIC and one or more RAN nodes. The second RIC includes at least one memory and at least one processor coupled to the at least one memory. The at least one processor is configured to receive, in a single request message from the first RIC, a request to create a plurality of policies, each including one or more policy statements.

An eighth aspect is directed to a method performed by a second RIC to be deployed between a first RIC and one or more RAN nodes. The method includes receiving, in a single request message from the first RIC, a request to create a plurality of policies, each including one or more policy statements.

In a ninth aspect, a first RIC includes at least one memory and at least one processor coupled to the at least one memory. The at least one processor is configured to receive, over an A1 interface, details regarding a cause of non-enforcement of an A1 policy from a second RIC located between the first RIC and one or more RAN nodes. The details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

In a tenth aspect, a method performed by a first RIC includes receiving, over an A1 interface, details regarding a cause of non-enforcement of an A1 policy from a second RIC located between the first RIC and one or more RAN nodes. The details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

An eleventh aspect is directed to a second to be deployed between a first RIC and one or more RAN nodes. The second RIC includes at least one memory and at least one processor coupled to the at least one memory. The at least one processor is configured to send details regarding a cause of non-enforcement of an A1 policy to the first RIC over an A1 interface. The details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

A twelfth aspect is directed to a method performed by a second RIC to be deployed between a first RIC and one or more RAN nodes. The method includes sending details regarding a cause of non-enforcement of an A1 policy to the first RIC over an A1 interface. The details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

A thirteenth aspect is directed to a program. The program includes a set of instructions (software code) that, when read into a computer, causes the computer to perform the method according to the second, fourth, sixth, eighth, tenth, or twelfth aspect described above.

### Advantageous Effects of Invention

According to the aspects described above, it is possible to provide apparatus, methods, and programs that contribute to solving at least one of a plurality of problems related to operations, procedures, and signaling on the A1 interface for A1 policy management, including the problems described above.

### BRIEF DESCRIPTION OF DRAWINGS

FIG. 1 shows an architecture related to A1, O1, and E2 interfaces, according to an example embodiment;

FIG. 2 shows an example of the functions of a Non-RT RIC and a

Near-RT RIC with respect to A1 policy management, according to an example embodiment;

FIG. 3 shows an example of the structure of an A1 policy in an example embodiment;

FIG. 4 is a sequence diagram showing an example of the operation of a Non-RT RIC and a Near-RT RIC according to an example embodiment;

FIG. 5 is a sequence diagram showing an example of the operation of a Non-RT RIC and a Near-RT RIC according to an example embodiment;

FIG. 6 is a sequence diagram showing an example of the operation of a Non-RT RIC and a Near-RT RIC according to an example embodiment;

FIG. 7 is a sequence diagram showing an example of the operation of a Non-RT RIC and a Near-RT RIC according to an example embodiment;

FIG. 8 is a sequence diagram showing an example of the operation of a Non-RT RIC and a Near-RT RIC according to an example embodiment;

FIG. 9 is a sequence diagram showing an example of the operation of a Non-RT RIC and a Near-RT RIC according to an example embodiment;

FIG. 10 is a sequence diagram showing an example of the operation of a Non-RT RIC and a Near-RT RIC according to an example embodiment;

FIG. 11 is a sequence diagram showing an example of the operation of a Non-RT RIC and a Near-RT RIC according to an example embodiment;

FIG. 12 is a sequence diagram showing an example of the operation of a Non-RT RIC and a Near-RT RIC according to an example embodiment;

FIG. 13 is a sequence diagram showing an example of the operation of a Non-RT RIC and a Near-RT RIC according to an example embodiment;

FIG. 14 is a sequence diagram showing an example of the operation of a Non-RT RIC and a Near-RT RIC according to an example embodiment;

FIG. 15 is a sequence diagram showing an example of the operation of a Non-RT RIC and a Near-RT RIC according to an example embodiment;

FIG. 16 is a sequence diagram showing an example of the operation of a Non-RT RIC and a Near-RT RIC according to an example embodiment;

FIG. 17 shows an example of the format of a policy status object according to an example embodiment;

FIG. 18 shows an example of the format of a policy status object according to an example embodiment;

FIG. 19 is a sequence diagram showing an example of the operation of a Non-RT RIC and a Near-RT RIC according to an example embodiment;

FIG. 20 is a sequence diagram showing an example of the operation of a Non-RT RIC and a Near-RT RIC according to an example embodiment;

FIG. 21 is a sequence diagram showing an example of the operation of an SMO framework, a Non-RT RIC, a Near-RT RIC, and an E2 Node according to an example embodiment; and

FIG. 22 is a block diagram showing an example configuration of a Non-RT RIC and a Near-RT RIC according to an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to a Non-RT RIC and a Near-RT RIC in accordance with the O-RAN technical specifications. However, these example embodiments can be applied to other systems that support technologies similar to the O-RAN Non-RT RIC and Near-RT RIC.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

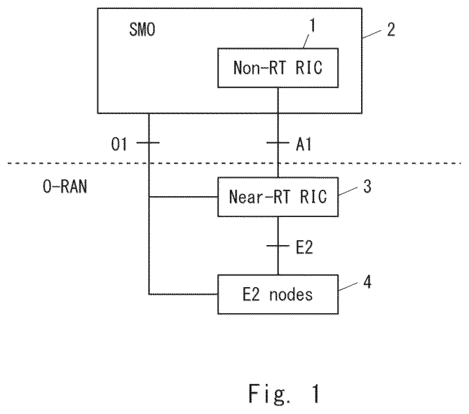

First, the configurations and operations of a plurality of elements that are common to a plurality of example embodiments are described. FIG. 1 shows an example configuration of a system according to a plurality of example embodiments. In the example in FIG. 1, the system includes a Non-RT RIC 1, an SMO framework 2, a Near-RT RIC 3, and one or more E2 Nodes 4. The SMO framework 2 may be referred to simply as SMO. Each element (network function) shown in FIG. 1 can be implemented, for example, as a network element on dedicated hardware, as a software instance running on dedicated hardware, or as a virtualized function instantiated on an application platform.

The Non-RT RIC 1 is a logical function within the SMO or within the SMO framework 2. The Non-RT RIC 1 includes a Non-RT RIC framework and Non-RT RIC Applications (rApps). The Non-RT RIC framework includes the functionality to logically terminate an A1 interface and expose a set of R1 services to rApps. The A1 termination allows the Non-RT RIC framework and the Near-RT RIC to exchange messages on an A1 interface. The set of R1 services includes A1-related services, O1-related services, and other services.

A1-related services include, among others, creating, updating, querying, and deleting A1 policies; querying the enforcement status of A1 policies; and subscribing to event notifications about A1 policies, including notifications of changes in the enforcement status of A1 policies.

O1-related services are provided by the SMO framework 2 and the Non-RT RIC framework. O1-related services allow rApps to obtain information about alarms, obtain performance information related to the network, obtain the current configuration of the network, provision changes to the configuration of the network, and obtain additional information related to the network.

The SMO framework 2 provides various logical functions that are not anchored within the Non-RT RIC 1. These logical functions include O1 termination, O2 termination, external terminations, and other functions. The O1 termination allows the SMO framework 1 to exchange messages with the Near-RT RIC 3 and E2 Nodes 4 on O1 interfaces. The O2 termination allows the SMO framework 2 to exchange messages with an O-Cloud on an O2 interface. The O-Cloud is a cloud computing platform consisting of a collection of physical infrastructure nodes that meet O-RAN requirements and host relevant O-RAN functions, supporting software components, and appropriate management and orchestration capabilities. The relevant O-RAN functions include, for example, a Near-RT RIC and E2 Nodes. The external terminations allow the SMO framework 2 or a Non-RT RIC framework to exchange messages with external entities via interfaces outside the scope of the O-RAN.

The Near-RT RIC 3 is a logical function that enables near real- time control and optimization of RAN elements and resources through fine-grained (e.g., UE basis, cell basis) data collection and actions on E2 interfaces. The Near-RT RIC hosts a set of applications called xApps and provides a set of platform functions that are commonly used to support specific functions hosted by xApps. The set of platform functions includes Database and Shared Data Layer (SDL), xApp subscription management, conflict mitigation, messaging infrastructure, interface termination, and application programming interface (API) enablement. The interface terminations include E2, A1, and O1 terminations, which provide E2 interface termination, A1 interface termination, and O1 interface termination, respectively.

An E2 interface connects the Near-RT RIC 3 to one or more E2 Nodes 4. An E2 Node 4 is a logical node that terminates an E2 interface. An E2 Node 4 is a RAN node that exposes one or more RAN functions to the Near-RT RIC 3 and hosted xApps. For NR access, E2 Nodes 4 include one or more O-CU-CPs, one or more O-CU-UPs, one or more O-DUs, or any combination thereof. On the other hand, for E-UTRA access, E2 Nodes 4 include one or more O-eNBs.

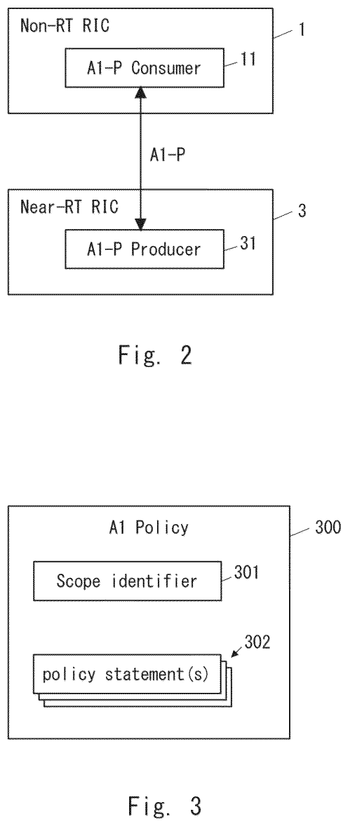

The following describes A1 policy management on the A1 interface. FIG. 2 shows an example of the functions of the Non-RT RIC 1 and the Near-RT RIC 3 with respect to the A1 Policy Management Service (A1-P). The A1 interface uses the A1 Application Protocol (A1AP). The A1AP provides Application Programming Interfaces (APIs) for the services defined in the A1 interface, including A1-P. With respect to A1-P, the Non-RT RIC 1 includes or provides an A1-P Consumer 11, while the Near-RT RIC 3 includes or provides an A1-P Producer 31. Requests are sent by the A1-P Consumer, while responses and notifications are sent by the A1-P Producer. The terms “Consumer” and “Producer” do not imply the direction of data transfer on the A1 interface.

The Non-RT RIC 1 defines A1 policies to be provided to the Near-RT RIC 3 via the A1 interface. A1 policies are declarative policies that contain statements about policy objectives and policy resources applicable to UEs and cells. The purpose of A1 policies is to guide the RAN performance towards the overall goal expressed in RAN Intent. In other words, the purpose of A1 policies is to allow the Non-RT RIC 1 within the SMO or the SMO framework 2 to guide the Near-RT RIC 3, and hence the RAN, to better meet the RAN Intent. The RAN Intent is an expression of high-level operational or business goals to be achieved by the RAN, allowing an operator to specify desired SLAs that the RAN needs to fulfill for all or a class of users in a given area over a given period of time.

The Non-RT RIC 1 manages A1 policies based on A1 policy feedback and on a network status provided over O1. The Non-RT RIC 1 continuously evaluates the impact of the A1 policies on the fulfillment of the RAN Intent, for example using the O1 observables, and decides, based on internal conditions, to issue or update the goals expressed in the A1 policies. The Near-RT RIC 3 functions based on its internal functions or applications, the configuration received over O1, and the temporary A1 policies received over A1.

An A1 policy type is identified by a policy type identifier (Policy TypeId). Different policy types have different Policy TypeIds. Based on the Policy TypeId, schemas are identified and used for creation, validation and formulation, and for query of the status, of A1 policies of that type.

An A1 policy is identified by a policy identifier (PolicyId) that is assigned by the Non-RT RIC 1. The PolicyId is locally unique within the Non-RT RIC 1 and is sent in policy request operations that carry representations of A1 policies.

As shown in FIG. 3, a single A1 policy 300 consists of a scope identifier 301 and one or more policy statements 302. The scope identifier 301 represents what the policy statement(s) 302 are to be applied on (e.g., UEs, QOS flows, or cells). The policy statement(s) 302 represent the goals to the Near-RT RIC 3 and covers policy objectives and policy resources. More specifically, an A1 policy is identified by a policy identifier (policyId) and is represented as a JSON object called a policy object (PolicyObject). A policy object contains a single scope identifier (e.g., the scope identifier 301) and at least one policy statement (e.g., the policy statement(s) 302). At least one policy statement may include one or more policy objective statements and/or one or more policy resource statements. The policy identifier (policyId) is assigned by the A1 Policy Management Service (A1-P) Consumer 11, i.e., the Non-RT RIC 1, during policy creation. Policy feedback for a specific A1 policy is subscribed to during policy creation by providing a callback Uniform Resource Identifier (URI).

Identifiers that can be used as scope identifiers in an A1 policy are defined as data types in Non-Patent Literature 5 (A1 Type Definitions Specification). A scope identifier may consist of any or a combination of these data types, as described in more detail in the policy type definitions in Non-Patent Literature 5. Specifically, a scope identifier may be a UE identifier (Ueid), a UE group identifier (GroupId), a slice identifier (SliceId), a QoS identifier (QosId), a cell identifier (CellId), or any combination thereof.

A1 Policy creation and enforcement can be performed on a per-policy basis. Accordingly, the operation to create multiple A1 policies can be a sequence of operations to create a single A1 policy. The operation of creating a single A1 policy is based on an HTTP PUT. The A1 policy to be created is identified by a URI containing policyId in the request line of the PUT request. The message body of the PUT request contains the Policy Object. The steps to create a single A1 policy are as follows. The A1-P Consumer 11 (i.e., the Non-RT RIC 1) generates a policyId and sends an HTTP PUT request to the A1-P Producer 31 (i.e., the Near-RT RIC 3). The target URI identifies the resource (policyId) under which the new policy shall be created. The message body carries a Policy Object. The A1-P Producer 31 returns an HTTP PUT response. On success, “201 Created” is returned, the location header carries the URI of the new policy, and the message body carries the Policy Object. On failure, the appropriate error code is returned, and the message body may contain additional error information. The A1-P Consumer 11 can request policy status updates for the created policy by including the notificationDestination as a query parameter in the PUT request. This is related to the feedback policy operation described below.

A query of the enforcement status of an A1 policy can be performed on a per-policy basis. The operation of querying the enforcement status of a single A1 policy is based on HTTP GET. The A1 policy for which the status is to be read is identified by a URI containing a policyId, while the message body is empty. The response by the A1-P Producer 31 returns a policy status object (Policy StatusObject). The Policy StatusObject indicates the enforcement status of the A1 policy and, if the enforcement status is NOT ENFORCED, other brief information about the cause of the non-enforcement.

As with A1 policy creation, A1 policy updates can be performed on a per-policy basis. Accordingly, the operation to update multiple A1 policies may be a sequence of operations to create a single A1 policy. The operation of updating a single A1 policy is based on an HTTP PUT. The A1 policy to be updated is identified by a URI containing policyId in the request line of the PUT request. The message body of the PUT request contains the Policy Object of the policy being updated.

Feedback policy is an operation that requires the A1-P Producer 31 (i.e., the Near-RT RIC 3) to have a reduced feature HTTP Client for sending HTTP POST requests and receiving HTTP POST responses. Correspondingly, the A1-P Consumer 11 (i.e., the Non-RT RIC 11) is required to have a reduced feature HTTP Server for receiving HTTP POST requests and sending HTTP POST responses. The A1-P Producer 31 may use the Feedback policy operation to notify the A1-P Consumer 11 about changes in the policy enforcement status for an A1 policy. The operation to provide policy feedback is based on HTTP POST. The URI in the request line of the POST request contains the target resource for policy notification handling. In other words, a policy feedback notification is sent to the URI for notification handling. The notification content is represented in a Policy StatusObject that is included in the message body of the POST request. The Policy StatusObject contains information about policy enforcement status changes and their causes. This procedure is used to notify about an enforcement status change of a policy between “enforced” and “not enforced”.

According to Non-Patent Literature 5 (A1 Type Definitions Specification), the policy status object (Policy Status Object) shall include an enforceStatus attribute. The enforceStatus attribute indicates the enforcement status of the A1 policy. The enforceStatus attribute is an enumeration (or enumerated) type that indicates ENFORCED or NOT_ENFORCED. ENFORCED indicates that the policy is enforced; NOT_ENFORCED indicates that the policy is not enforced. In addition, when the enforceStatus attribute is NOT_ENFORCED, the Policy StatusObject contains an enforceReason attribute. The enforceReason attribute indicates a short reason for the change in enforcement status (or a brief reason for sending the notification). The enforceReason attribute is an enumerated type that indicates SCOPE_NOT_APPLICABLE, STATEMENT_NOT_APPLICABLE, or OTHER_REASON. SCOPE_NOT_APPLICABLE indicates that the scope provided can no longer be applied to enforce the policy. STATEMENT_NOT_APPLICABLE indicates that the policy statement(s) cannot be applied due to other changes. OTHER_REASON is set to the enforceReason attribute when the policy can no longer be enforced for reasons other than the scope or the statement becoming inapplicable.

The above description of the existing operations, procedures, and signaling on the A1 interface for A1 policy management is based on the O-RAN technical specifications as of the filing date of this application. The plurality of example embodiments described below provide improvements over these existing operations, procedures, and signaling for A1 policy management. Accordingly, some of the existing operations, procedures, and signaling related to A1 policy management described above may be modified as appropriate in the following example embodiments. Additionally or alternatively, the following example embodiments may provide additional operations, procedures, or signaling in addition to or in lieu of the existing operations, procedures, and signaling for A1 policy management described above.

### First Example Embodiment

An example configuration of a system according to this example embodiment may be the same as the examples shown in FIGS. 1 and 2. This example embodiment provides improved feedback on the enforcement status of A1 policies.

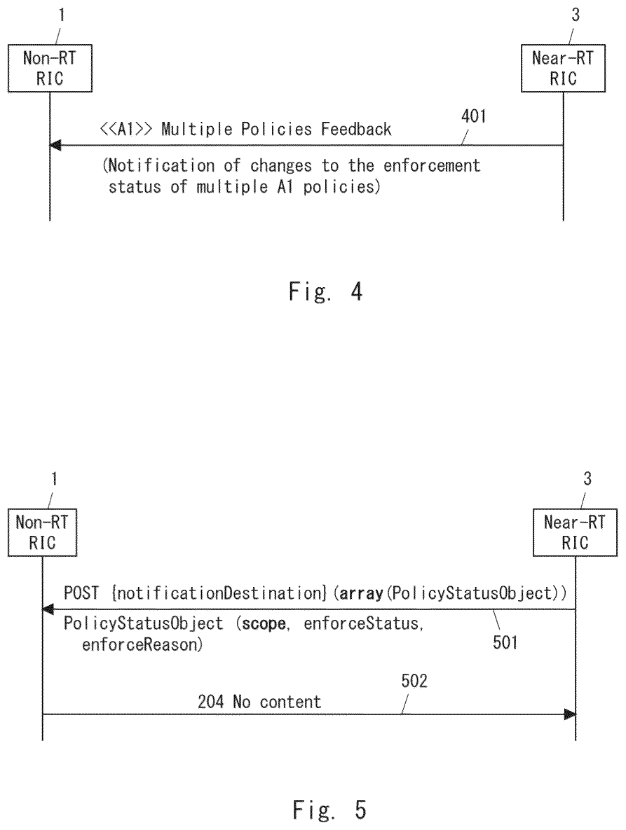

FIG. 4 shows an example of the operation of the Non-RT RIC 1 and the Near-RT RIC 3 according to this example embodiment. In step 401, the Near-RT RIC 3 sends feedback regarding the enforcement status of a plurality of A1 policies to the Non-RT RIC 1 over the A1 interface in a single message. The Non-RT RIC 1 receives the feedback regarding the enforcement status of the plurality of A1 policies from the Near-RT RIC 3 over the A1 interface in the single message. The single message may be an HTTP POST request message.

The feedback regarding the enforcement status of the plurality of A1 policies notifies the Non-RT RIC 1 of changes in the enforcement status of each A1 policy. In other words, the feedback on the enforcement status of the plurality of A1 policies indicates a change in the enforcement status of each A1 policy. As described above, each A1 policy contains a scope identifier (e.g., scope identifier 301) and one or more policy statements (e.g., policy statement 302). The reason for the change in enforcement status of each A1 policy can be SCOPE_NOT_APPLICABLE, STATEMENT_NOT_APPLICABLE, or OTHER_REASON. The multiple A1 policy enforcement status feedbacks that are merged within the single message may indicate different reasons for the change from each other, or they may indicate the same reason for the change. In other words, the respective reasons for the change in the enforcement status of the multiple A1 policies may be the same, or they may be partially or completely different.

The plurality of A1 policies that are subject to enforcement status feedback using a single message can be determined in various ways or using various criteria. In the first example, these multiple A1 policies may be any multiple A1 policies that the Non-RT RIC 1 has requested the Near-RT RIC 3 to create or set up. In the second example, these multiple A1 policies may each have the same scope identifier. In the third example, the scope identifier in each of these multiple A1 policies may include at least one common identifier (e.g., UE identifier or cell identifier). In the fourth example, these multiple A1 policies may each contain the same set of one or more policy statements. In the fifth example, a set of policy statements in each of these multiple A1 policies may contain at least one common policy statement.

In the sixth example, these multiple A1 policies may be A1 policies that have been indicated by the Non-RT RIC 1 to be associated with each other during policy creation. In other words, the Non-RT RIC 1 may explicitly or implicitly indicate to the Near-RT RIC 3, during the creation of these multiple policies, that the A1 policies are associable with each other for feedback. Multiple A1 policies whose enforcement status changes are reported to the Non-RT RIC 1 by the Near-RT RIC 3 in a single message may be a subset of the set of A1 policies associated by the Non-RT RIC 1 during policy creation.

To imply such an association of multiple A1 policies to the Near-RT RIC 3 for policy feedback, the Non-RT RIC 1 may create or set up these multiple A1 policies in a single HTTP transaction with the Near-RT RIC 3. Enhancements for creating multiple A1 policies in a single HTTP transaction are described later.

Alternatively, to imply such an association of multiple A1 policies to the Near-RT RIC 3 for policy feedback, the Non-RT RIC 1 may provide the same policy group identifier to the Near-RT RIC 3 in multiple HTTP transactions to create the multiple A1 policies. In other words, a new policy group identifier can be defined to accomplish this. The enhanced policy creation operation using the policy group identifier is described later.

Alternatively, to imply such an association of multiple A1 policies to the Near-RT RIC 3 for policy feedback, the Non-RT RIC 1 may provide the same callback URI or the same Notification Destination to the Near-RT RIC 3 in multiple HTTP transactions to create the multiple A1 policies. Details of this policy creation operation are also described later.

The following are specific examples of the structure of a single message (step 401 in FIG. 4) that provides feedback on the enforcement status of multiple A1 policies. In one example, the single message may include multiple scope identifiers, each of which is included in a respective one of the multiple A1 policies. Additionally or alternatively, the single message may include multiple policy identifiers, each of which indicates a respective one of the multiple A1 policies. Additionally or alternatively, the single message may contain multiple other identifiers, each of which is associated with a respective one of the multiple A1 policies.

FIG. 5 shows an example where a single message contains multiple scope identifiers of multiple A1 policies. In step 501, the Near-RT RIC 3 sends an HTTP POST request message to the Non-RT RIC 1. The message body of the HTTP POST request message in step 501 contains an array of policy status objects (Policy StatusObject). In addition to the enforceStatus and enforceReason attributes, each policy status object also contains a scope attribute that specifies the scope identifier. This allows each policy status object to be associated with a single corresponding A1 policy. In step 502, the Non-RT RIC 1 returns an HTTP POST response with “204 No Content”. The message body is empty.

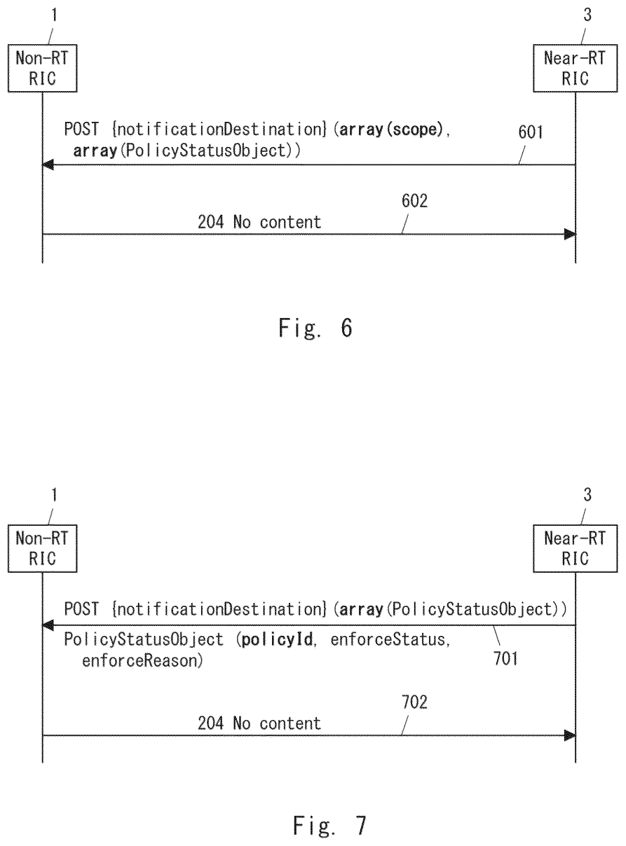

FIG. 6 shows another example where a single message contains multiple scope identifiers of multiple A1 policies. In step 601, the Near-RT RIC 3 sends an HTTP POST request message to the Non-RT RIC 1. The message body of the HTTP POST request message in step 601 contains an array of scope identifiers (scope) and an array of policy status objects. The multiple scope identifiers in the array of scope identifiers may be mapped one-to-one to the multiple policy status objects in the array of policy status objects, according to the order of the instances in these two arrays. As with existing policy status objects, each policy status object contains an enforceStatus attribute, and may also contain an enforceReason attribute depending on the conditions. In step 602, the Non-RT RIC 1 returns an HTTP POST response with “204 No Content”. The message body is empty.

FIG. 7 shows an example where a single message contains multiple policy identifiers of multiple A1 policies. In step 701, the Near-RT RIC 3 sends an HTTP POST request message to the Non-RT RIC 1. The message body of the HTTP POST request message in step 701 contains an array of policy status objects. In addition to the enforceStatus and enforceReason attributes, each policy status object also contains a policyId attribute that specifies the policy identifier. This allows each policy status object to be associated with a single corresponding A1 policy. In step 702, the Non-RT RIC 1 returns an HTTP POST response with “204 No Content”. The message body is empty.

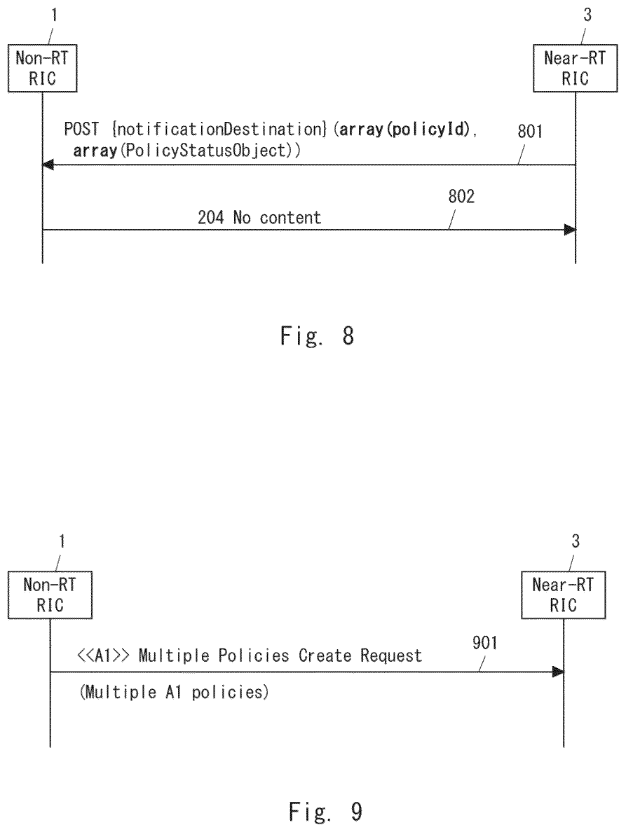

FIG. 8 shows another example where a single message contains multiple policy identifiers of multiple A1 policies. In step 801, the Near-RT RIC 3 sends an HTTP POST request message to the Non-RT RIC 1. The message body of the HTTP POST request message in step 801 contains an array of policy identifiers (policyId) and an array of policy status objects. The multiple policy identifiers in the array of policy identifiers may be mapped one-to-one to the multiple policy status objects in the array of policy status objects, according to the order of the instances in these two arrays. As with existing policy status objects, each policy status object contains an enforceStatus attribute, and may also contain an enforceReason attribute depending on the conditions. In step 802, the Non-RT RIC 1 returns an HTTP POST response with “204 No Content”. The message body is empty.

The following are enhancements to the operation for creating multiple A1 policies. For example, as mentioned above, a new operation or procedure can be defined for creating multiple A1 policies in a single HTTP transaction. By way of example, and not limitation, this operation or procedure can be called a “Create multiple policies” operation, a “Multiple policies Create” operation, or a “Multiple policies creation” operation. FIG. 9 shows an example of the Create multiple polices operation. In step 901, the Non-RT RIC 1 sends a request to create multiple policies to the Near-RT RIC 3 in a single request message. The request message may be an HTTP PUT request message. The request message may contain multiple scope identifiers, each of which is contained in a respective one of the multiple A1 policies. The request message may contain multiple policy identifiers corresponding to the multiple A1 policies. The request message may contain a policy group identifier assigned to the multiple A1 policies by the Non-RT RIC 1.

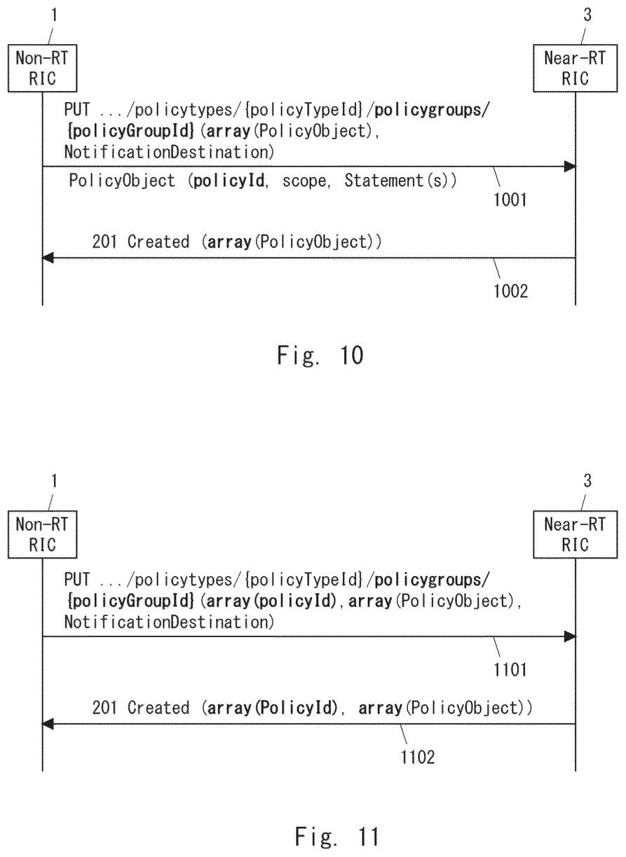

FIG. 10 shows a more concrete example of the Create multiple polices operation. In step 1001, the Non-RT RIC 1 sends an HTTP PUT request message to the Near-RT RIC 3. To indicate that this is an operation on multiple A1 policies within a single policy group, the (resource) URI in the request line of the HTTP PUT request message in step 1001 is extended to specify the policy group identifier. Specifically, in the example in FIG. 10, the HTTP PUT request (1001) specifies “URI: . . . /policytypes/{policy TypeId}/policygroups/{policy GroupId}” to which the policy GroupId has been added.

In addition, the message body of the HTTP PUT request message in step 1001 contains an array of policy objects. As with the existing one, each policy object includes a scope attribute and one or more statements attributes. The one or more statements attributes can include any combination of the qosObjectives, qoeObjectives, ueLevelObjectives, sliceSlaObjectives, lbObjectives, tspResources, sliceSlaResources, and lbResources attributes. In addition to these attributes, which are the same as those of existing ones, each policy object additionally contains a policyId attribute that specifies a policy identifier. This allows each policy object to be associated with a single corresponding A1 policy.

In step 1002, the Near-RT RIC 3 returns an HTTP PUT response to the Non-RT RIC 1. On success, “201 Created” is returned and the message body carries the array of Policy Objects. The location header of the HTTP PUT response may indicate the URI of the policy group.

FIG. 11 shows another more concrete example of the Create multiple polices operation. In step 1001, the Non-RT RIC 1 sends an HTTP PUT request message to the Near-RT RIC 3. As in the example in FIG. 10, the URI of the HTTP PUT request message in step 1101 is extended to specify the policy group identifier. The message body of the HTTP PUT request message in step 1101 contains an array of policy identifiers (policy Id) and an array of policy objects. The multiple policy identifiers in the policy identifier array may be mapped one-to-one to the multiple policy objects in the policy object array, according to the order of the instances in these two arrays.

In step 1102, the Near-RT RIC 3 returns an HTTP PUT response to the Non-RT RIC 1. On success, “201 Created” is returned and the message body carries the array of Policy Objects. In the example in FIG. 11, the message body also carries the array of policy identifiers. The array of policy identifiers may be omitted. The location header of the HTTP PUT response may indicate the URI of the policy group.

The Non-RT RIC 1 may instruct the Near-RT RIC 3 whether feedback regarding the enforcement status of multiple policies should be sent to the Non-RT RIC 1 in a single feedback message or in multiple individual feedback messages. This instruction may be provided in the policy creation request message in step 901, 1001, or 1101.

For example, if the Non-RT RIC 1 wishes to receive a single feedback message, the Non-RT RIC 1 may include only a single callback URI or Notification Destination in the policy creation request message in step 901, 1001, or 1101. On the other hand, if multiple individual feedback messages are preferred, the Non-RT RIC 1 may include multiple callback URIs or Notification Destinations corresponding to the multiple A1 policies to be created in the policy creation request message in step 901, 1001, or 1101.

In another example, if the Non-RT RIC 1 wishes to receive a single feedback message, the Non-RT RIC 1 may include a first indication of this in the policy creation request message in step 901, 1001, or 1101. On the other hand, if multiple individual feedback messages are preferred, the Non-RT RIC 1 may omit the first indication from the policy creation request message in step 901, 1001, or 1101. Alternatively, the Non-RT RIC 1 may include a second indication in the policy creation request message expressing a preference for multiple individual feedback messages.

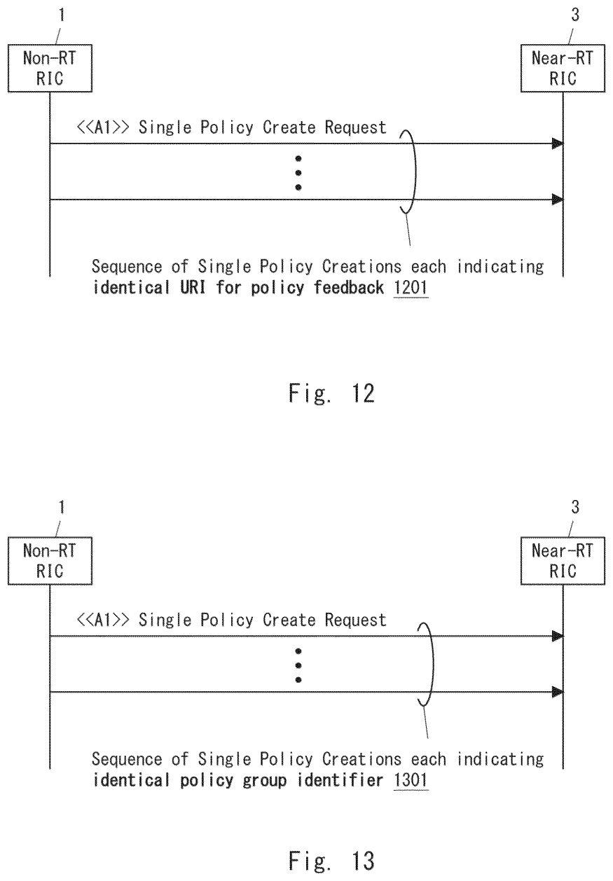

Next, some example operations for creating multiple A1 policies in multiple HTTP transactions are explained with reference to FIGS. 12 and 13. In the example in FIG. 12, in a case where the Non-RT RIC 1 sends multiple single policy creation requests to create multiple A1 policies, it includes the same callback URI or Notification Destination for policy feedback in each of these multiple requests (1201). The Near-RT RIC 3 may recognize that it is permitted to send feedback on the enforcement status of the multiple A1 policies associated with the same callback URI or Notification Destination in a single message.

On the other hand, in the example shown in FIG. 13, in a case where the Non-RT RIC 1 sends multiple single policy creation requests to create multiple A1 policies, it includes the same policy group identifier in each of these multiple requests (1301). The Near-RT RIC 3 may recognize that it is permitted to send feedback on the enforcement status of the multiple A1 policies associated with the same policy group identifier in a single message.

The operations described in this example embodiment allow the Non-RT RIC 1 and the Near-RT RIC 3 to transfer policy feedback regarding changes in the enforcement status of multiple A1 policies in a single message. This helps to reduce the number of HTTP transactions required to provide feedback on the enforcement status of multiple A1 policies.

### Second Example Embodiment

An example configuration of a system according to this example embodiment may be the same as the examples shown in FIGS. 1 and 2. This example embodiment provides improved operations for creating multiple A1 policies.

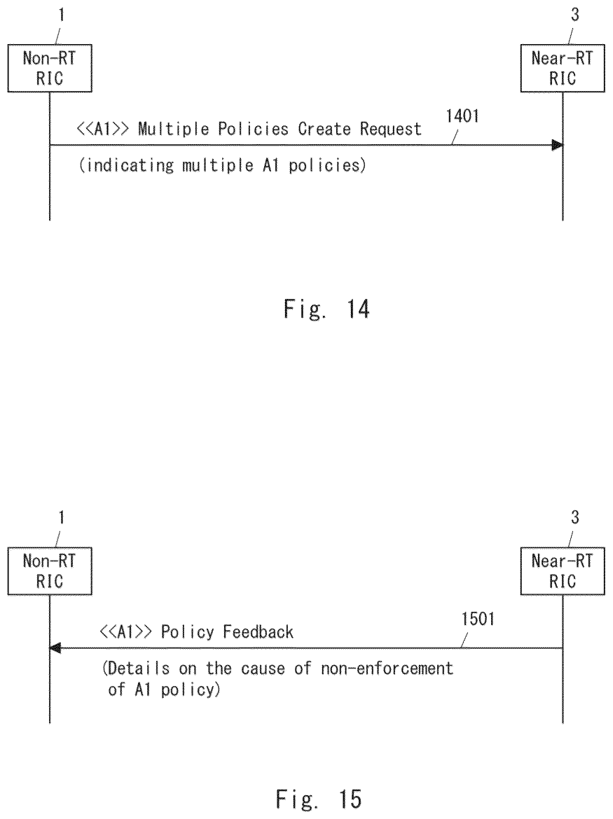

FIG. 14 shows an example of the operation of the Non-RT RIC 1 and the Near-RT RIC 3 according to this example embodiment. The operation or procedure in FIG. 14 allows multiple A1 policies to be created in a single HTTP transaction. By way of example, and not limitation, this operation or procedure may be called a Create multiple policies operation, a Multiple policies Create operation, or a Multiple policies creation operation. The operation or procedure shown in FIG. 14 may be partially or completely the same as the operation or procedure explained with reference to FIG. 9. In other words, the multiple A1 policy creation operation explained with reference to FIG. 9 need not necessarily be used in conjunction with the operation for providing feedback on the enforcement status of multiple A1 policies explained with reference to FIGS. 4 to 8. The operation to create multiple A1 policies, as explained with reference to FIG. 9, can be used independently of the operation to provide feedback on the enforcement status of multiple A1 policies.

In step 1401, the Non-RT RIC 1 sends a request to create multiple policies to the Near-RT RIC 3 in a single request message. The structure of the request message and the behavior of the Near-RT RIC 3 that receives it may be the same as those described with reference to FIG. 9. Duplicate explanations are omitted here.

More specific examples of the Create multiple polices operation shown in FIG. 14 may be the same as those explained with reference to FIGS. 10 and 11. Duplicate explanations are omitted here.

The Non-RT RIC 1 may instruct the Near-RT RIC 3 whether feedback regarding the enforcement status of multiple policies should be sent to the Non-RT RIC 1 in a single feedback message or in multiple individual feedback messages. This instruction may be provided in the policy creation request message in step 1401 or 1501.

For example, if the Non-RT RIC 1 wishes to receive a single feedback message, the Non-RT RIC 1 may include only a single callback URI or Notification Destination in the policy creation request message in step 1401 or 1501. On the other hand, if multiple individual feedback messages are preferred, the Non-RT RIC 1 may include multiple callback URIs or Notification Destinations corresponding to the multiple A1 policies to be created in the policy creation request message in step 1401 or 1501.

In another example, if the Non-RT RIC 1 wishes to receive a single feedback message, the Non-RT RIC 1 may include a first indication of this in the policy creation request message in step 1401 or 1501. On the other hand, if multiple individual feedback messages are preferred, the Non-RT RIC 1 may omit the first indication from the policy creation request message in step 1401 or 1501. Alternatively, the Non-RT RIC 1 may include a second indication in the policy creation request message expressing a preference for multiple individual feedback messages.

The multiple A1 policies that are subject to policy creation using a single message can be determined in various ways or based on various criteria. In the first example, these multiple A1 policies may be any multiple policies determined by the Non-RT RIC 1. In the second example, these multiple A1 policies may each have the same scope identifier. In the third example, the scope identifier in each of these multiple A1 policies may include at least one common identifier (e. g., UE identifier or cell identifier). In the fourth example, these multiple A1 policies may each contain the same set of one or more policy statements. In the fifth example, a set of policy statements in each of these multiple A1 policies may contain at least one common policy statement.

The operations described in this example embodiment allow the Non-RT RIC 1 and the Near-RT RIC 3 to send requests to create multiple A1 policies in a single message. This helps to reduce the number of HTTP transactions required to create multiple A1 policies.

### Third Example Embodiment

An example configuration of a system according to this example embodiment may be the same as the examples shown in FIGS. 1 and 2. This example embodiment relates to improvements for providing more detailed information about non-enforcement of A1 policies on the A1 interface.

FIG. 15 shows an example of the operation of the Non-RT RIC 1 and the Near-RT RIC 3 according to this example embodiment. FIG. 15 shows improvements or enhancements to the existing feedback policy. In step 1501, the Near-RT RIC 3 sends policy feedback regarding changes in the enforcement status of an A1 policy to the Non-RT RIC 1. This policy feedback may be an HTTP POST request. As with existing policy feedback, it may include an enforceStatus attribute, and it may also include an enforceReason attribute if the enforceStatus attribute is NOT_ENFORCED.

In addition, if the enforceStatus attribute is NOT_ENFORCED, the policy feedback also provides details regarding the cause of the non-enforcement of the A1 policy. The details regarding the cause of the non-enforcement of the A1 policy indicate (a) a changed new value of at least one identifier included in the scope identifier associated with the A1 policy, (b) a reason why one or more policy statements of the A1 policy are inapplicable, or a combination thereof. In other words, the details of the cause of the non-enforcement of the A1 policy include information required or used by the Non-RT RIC 1 to update the A1 policy. This information can be used by the Non-RT RIC 1 to determine the scope (scope identifier) after the A1 policy update, one or more policy statements after the A1 policy update, or both.

The policy feedback may include one or more additional attributes, fields, or information elements to provide details about the cause of the non-enforcement of the A1 policy. By way of example, and not limitation, the name of such an attribute, field, or information element may be a causeInfo attribute.

The policy feedback shown in FIG. 15 can be extended to be able to provide feedback on multiple A1 policies in the same manner as described in the first example embodiment.

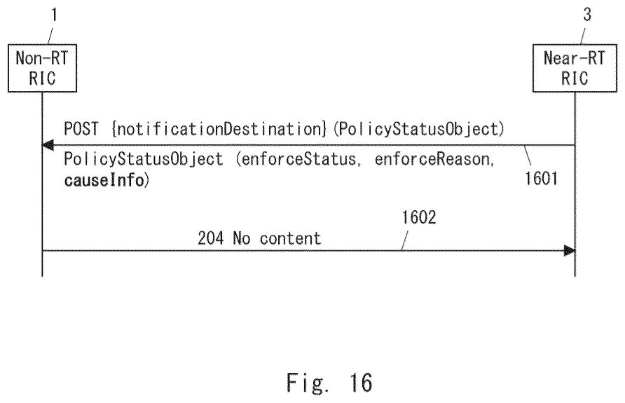

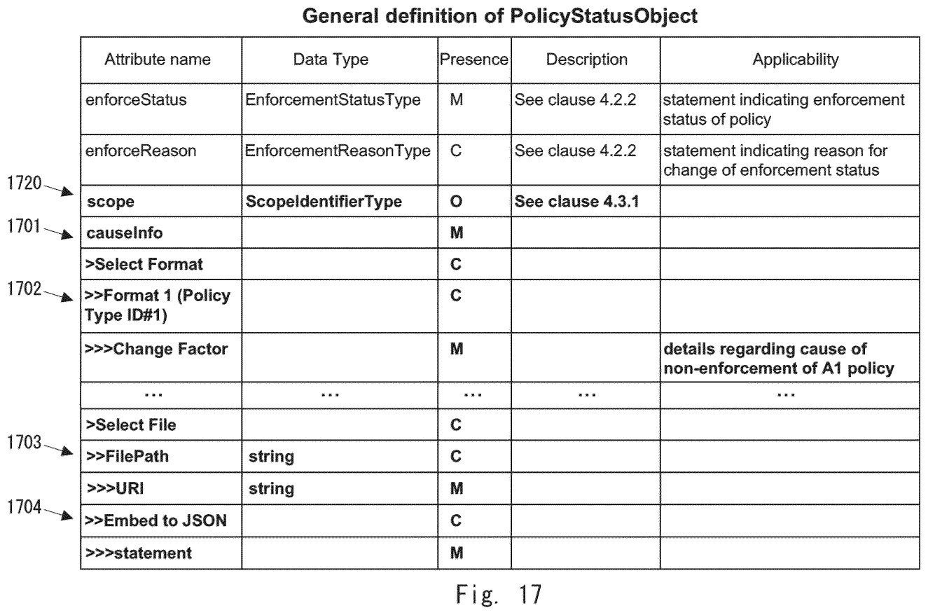

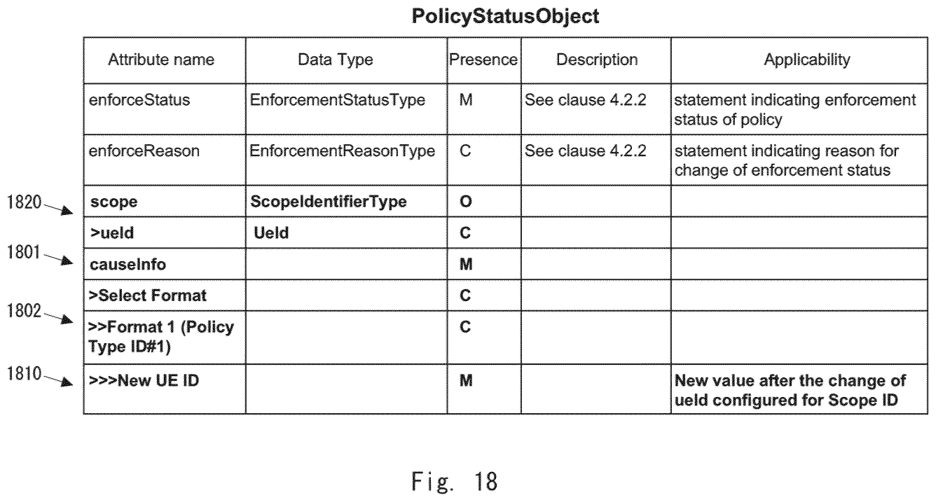

FIG. 16 shows a concrete example of the extended policy feedback shown in step 1501 of FIG. 15. In step 1601, the Near-RT RIC 3 sends an HTTP POST request message to the Non-RT RIC 1. The message body of the HTTP POST request message contains a policy status object (Policy Status Object). In addition to the enforceStatus and enforceReason attributes, the policy status object also includes the causeInfo attribute. The causeInfo attribute provides details about the cause of the non-enforcement of the A1 policy. The Policy Status Object may also include a scope attribute that indicates the scope identifier. In an example, the policy status object may include the scope attribute in a case where the single policy feedback message indicates feedback on multiple A1 policies. In another example, the scope attribute in the policy status object may specify one or more identifiers (e.g., UE identifier, cell identifier, slice identifier) that are relevant to the details of the cause of the non-enforcement specified by the causeInfo attribute. In step 1602, the Non-RT RIC 1 returns an HTTP POST response with “204 No Content”. The message body is empty.

FIG. 17 shows a specific example of the structure or format of the Policy Status Object. The contents of the causeInfo attribute (1701) may be in a format (1702) that is defined per use case (e.g., policy type identifier). Additionally or alternatively, the contents of the causeInfo attribute (1701) may specify a file path (1703) that stores detailed information about the cause of non-enforcement of the A1 policy. Additionally or alternatively, the contents of the causeInfo attribute (1701) may include an embedded JSON file (1704).

In the example in FIG. 17, the policy status object (Policy StatusObject) contains a scope attribute (1720) that specifies the scope identifier. In one example, the policy status object (Policy StatusObject) may contain the scope attribute (1720) if a single policy feedback message indicates feedback on multiple A1 policies. In another example, the scope attribute (1720) may specify one or more identifiers (e.g., UE identifier, cell identifier, slice identifier) that are relevant to the details of the cause of non-enforcement specified in the causeInfo attribute (1701). Otherwise, the scope attribute (1720) may be omitted.

FIG. 18 shows a concrete example of the policy status object (Policy StatusObject). The example in FIG. 18 refers to a case where the UE identifier within the scope of the A1 policy changes due to a handover or other reason, rendering the A1 policy unenforceable. In this case, the causeInfo attribute (1801) specifies the updated new value (1810) of the UE identifier contained in the scope identifier.

In FIG. 18, the new UE identifier (1810) is associated with, but not limited to, the format of Policy Type Identifier #1 (1802). The Non-RT RIC 1, which is the A1-P Consumer, can use a Query policy type operation or procedure to learn the policy type identifiers of the policy types supported by the Near-RT RIC 3, which is the A1-P Producer, and can receive the JSON schema for each policy type from the Near-RT RIC 3. The JSON schema for each policy type includes one JSON schema for Policy Object and one JSON schema for PolicyStatusObject. The format per policy type identifier in FIGS. 17 and 18 can simply follow the JSON schema for the Policy Status Object provided by the Near-RT RIC 3.

In the example in FIG. 18, the scope attribute (1820) identifies the UE identifier. This may indicate the value of the UE identifier prior to the change provided by the Non-RT RIC 1 in the creation or update operation of the A1 policy. Note that even if the scope attribute (1820) is not present, it is possible to determine which A1 policy the Policy StatusObject in question relates to from the URI (Notification Destinations) of the policy feedback that contains the

PolicyStatusObject in question. Therefore, the scope attribute (1820) can be omitted. The scope attribute (1820) may be included only when a single policy feedback message indicates feedback on multiple A1 policies.

It will be appreciated by those skilled in the art that extensions similar to the feedback policy operations described with reference to FIGS. 15 to 18 can also be made to the existing operations or procedures (i.e., the Query Policy Status procedure) for querying the enforcement status of an A1 policy. Specifically, as already explained, the operation for querying the enforcement status of a single A1 policy is based on HTTP GET. The Non-RT RIC 1 (A1-P Consumer 11) sends an HTTP GET request to the Near-RT RIC 3 (A1-P Producer 31). The A1 policy for which the status is to be read is identified by a URI containing a policyId in the request line of the HTTP GET request. The HTTP GET response from the Near-RT RIC 3 (A1-P Producer 31) contains a policy status object (Policy StatusObject) in its message body. This policy status object (Policy StatusObject) may provide details about the cause of non-enforcement of the A1 policy, in the same way as the feedback policy operations described in FIGS. 15 to 18.

Instead, the Non-RT RIC 1 may receive details of the cause of non-enforcement of an A1 policy from the Near-RT RIC 3 in one or more new A1 policy procedures other than the Feedback Policy Procedure and the Query Policy Status Procedure. The newly defined procedure may include a push-type procedure similar to the feedback policy procedure, as shown in FIG. 19. In the example in FIG. 19, in step 1901, the Near-RT RIC 3 sends a Push Detail Info message to the Non-RT RIC 1 providing details on the cause of non-enforcement of an A1 policy. In other words, in the Push Detail Info operation or procedure, the Near-RT RIC 3 sends a message to the Non-RT RIC 1 providing details about the cause of non-enforcement of an A1 policy. This message may be an HTTP POST request.

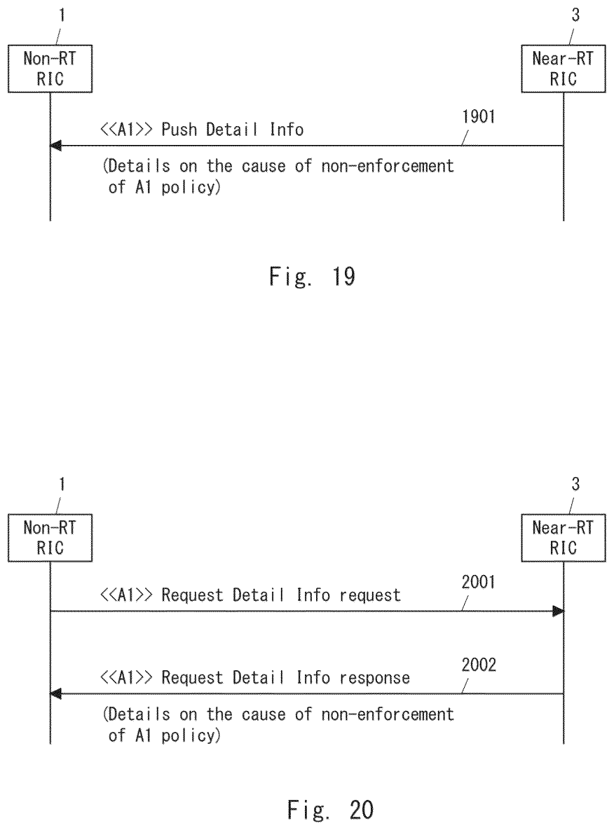

In addition, or alternatively, the newly defined procedure may include a pull-type procedure similar to the Query Policy Status procedure, as shown in FIG. 20. In the example in FIG. 20, in step 2001, the Non-RT RIC 1 sends a Request Detail Info request message to the Near-RT RIC 3. In step 2002, the Near-RT RIC 3 sends a Request Detail Info response message to the Non-RT RIC 1 providing details of the cause of non-enforcement of an A1 policy. This operation or procedure may be based on HTTP GET.

In some cases, the Non-RT RIC 1 may be able to complete the update of the A1 policy without using O1 observables, based on the detailed information about the cause of the non-enforcement of the A1 policy received from the Near-RT RIC 3 over the A1 interface. In this case, compared to using O1 observables, the time it takes for the Non-RT RIC 1 to update and (re) enforce the A1 policy after learning of the non-enforcement of the A1 policy can be reduced. This can help to facilitate dynamic updating of the A1 policy, for example in response to rapid changes in the wireless environment.

In other cases, however, the Non-RT RIC 1 would need additional information received from the Near-RT RIC 3 or the E2 Node 4 over the O1 interface to update the A1 policy. In this case, the Non-RT RIC 1 may collect information via the Ol interface in addition to the A1 policy management procedure described in the example embodiment. The Non-RT RIC 1 may then update the A1 policy by further considering the information received from the Near-RT RIC 3 or the E2 Node 4 via the Ol interface. As can be understood from these points, this example embodiment does not force the Non-RT RIC 1 to update the A1 policy by relying solely on the detailed information about the cause of the non-enforcement of the A1 policy received over the A1 interface.

For example, through the A1 interface, only the information that is essential for updating the policy or that is of the highest urgency is collected, from the detailed information on the cause of non-enforcement of the A1 policy. And the O1 interface can be used to collect the optional or large-sized information on the causes of the non-enforcement of the A1 policy through the O1 interface. Even in this case, there may be cases where the time required to update and (re)enforce the A1 policy can be reduced compared to collecting all the detailed information on the causes of the non-enforcement of the A1 policy through the O1 interface. As a result, this can help to facilitate dynamic updating of the A1 policy, for example in response to rapid changes in the wireless environment.

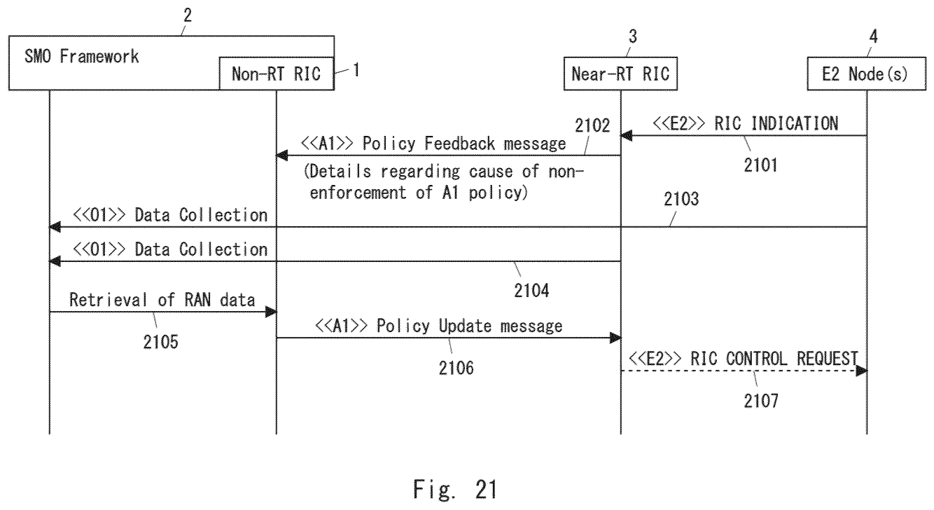

FIG. 21 shows an example where information is collected through the O1 interface in addition to the A1 interface. In step 2101, the Near-RT RIC 3 receives one or more RIC INDICATION messages from one or more E2 Nodes 4 over the E2 interface. These RIC INDICATION messages may be, for example, RIC INDICATION messages based on the E2 Service Model (E2SM) RAN Control (RC) REPORT Service Style 4: UE Information. This REPORT service style is initiated by the E2SM-RC Event Trigger style 4: UE Information Change. This event trigger style is used to detect changes in UE context information.

The UE context information changes supported as event triggers are changes in the Radio Resource Control (RRC) state, changes in the UE identifier, or changes in the Packet Data Convergence Protocol (PDCP), Radio Link Control (RLC), or Medium Access Control (MAC) state variables. The event trigger related to the UE identifier change can be “New UE Connected”, “UE Handed Over”, “UE ID Changed”, or “UE ID Removed”. The New UE Connected event trigger is triggered when a new UE ID is assigned to a newly connected UE. The UE Handed Over event trigger is triggered when a new UE ID is assigned due to a handover from another node. The UE ID Changed event trigger is triggered when the content of the assigned UE ID is changed. The UE ID Removed event trigger is triggered when the UE is released and its UE ID is deleted. The RIC INDICATION message in step 2101 can be any of the UE context information changes described above. For example, the RIC INDICATION message in step 2101 may be triggered by a change in the UE identifier.

In step 2102, the Near-RT RIC 3 sends a Policy Feedback message to the Non-RT RIC 1 over the A1 interface. For example, the Near-RT RIC 3 may determine that an A1 policy can no longer be enforced based on the RIC INDICATION message in step 2101, and may send a Policy Feedback message accordingly. The sending of the Policy Feedback message may be the same as that described with reference to FIG. 16. The Policy Feedback message provides details of the cause of the non-enforcement of the A1 policy. The Policy Feedback message may only contain information that is essential or urgently needed to update the A1 policy. The Policy Feedback message may specify an updated new value of the UE identifier contained in the scope identifier associated with the A1 policy.

In steps 2103 and 2104, the SMO framework 2 may collect RAN data or information via the O1 interface as required. Either or both of steps 2103 and 2104 may be performed. In other words, the SMO framework 2 may collect RAN data or information from the Near-RT RIC 3, or from one or more E2 Nodes 4, or from both. Specifically, the Non-RT RIC 1 may request or instruct the SMO framework 2 for additional RAN observations, and the SMO framework 2 may collect additional RAN data or information via the O1 interface. In Step 2105, the Non-RT RIC 1 receives the collected RAN data or information from the SMO framework 2. The RAN data or information may be optional information or large-sized information among the detailed information about the cause of the non-enforcement of the A1 policy. The RAN data or information may be additional information that is necessary or available for the A1 policy update.

In step 2106, the Non-RT RIC 1 requests the Near-RT RIC 3 to update the A1 policy via the A1 interface. To create the updated A1 policy, the Non-RT RIC 1 uses the information received in step 2102 regarding the details of the cause of the non-enforcement of the A1 policy. As an option, the Non-RT RIC 1 may use the RAN data or information based on the O1 observables received in step 2105 to create the updated A1 policy.

The Near-RT RIC 3 enforces the updated A1 policy received from the Non-RT RIC 1. If necessary, in step 2107, the Near-RT RIC 3 sends a RIC CONTROL REQUEST message to one or more E2 Nodes 4 over the E2 interface.

The operation described in this example embodiment allows the Non-RT RIC 1 to receive details about the cause of non-enforcement of an A1 policy from the Near-RT RIC 3 via the A1 interface. This allows the Non-RT RIC 1 to obtain information via the A1 interface that can be used to update the A1 policy via the A1 interface. For example, this can help to reduce the amount of information that the Non-RT RIC 1 needs to obtain over the O1 interface to update the A1 policy. In addition, in some cases, the time required to update and (re)enforce the A1 policy after the Non-RT RIC 1 becomes aware of the non-enforcement of the A1 policy can be reduced. This can help to facilitate dynamic updating of the A1 policy, for example in response to rapid changes in the wireless environment.

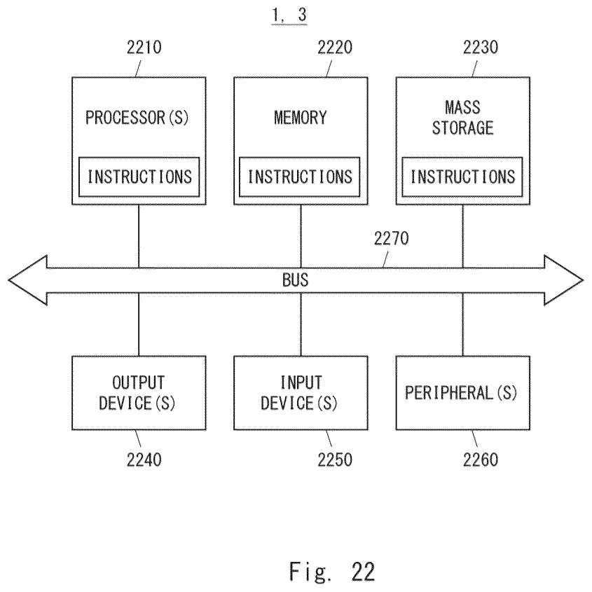

Examples of configurations of the Non-RT RIC 1 and the Near-RT RIC 3 according to the example embodiments described above are provided below. FIG. 22 is a block diagram showing an example configuration of the Non-RT RIC 1. The Near-RT RIC 3 may also have a configuration similar to that shown in FIG. 22.

In the example in FIG. 22, the Non-RT RIC 1 is implemented as a computer system. The computer system includes one or more processors 2210, a memory 2220, and a mass storage 2230, which communicate with one another via a bus 2270. The one or more processors 2210 may include, for example, one or both of a Central Processing Unit (CPU) and a Graphics Processing Unit (GPU). The computer system may include other devices, such as one or more output devices 2240, one or more input devices 2250, and one or more peripherals 2260. The one or more peripheral devices 2260 may include a modem, or network adapter, or any combination thereof.

One or both of the memory 2220 and the mass storage 2230 include a computer-readable medium storing one or more sets of instructions. Some or all of these instructions may be stored in a memory in the one or more processors 2210. These instructions, when executed in the one or more processors 2210, cause the one or more processors 2210 to provide the functions of the Non-RT RIC 1 described in the above example embodiments.

As explained using FIG. 22, each of the processors of the Non- RT RIC 1 and the Near-RT RIC 3 according to the above example embodiments is capable of executing one or more programs containing a set of instructions for causing a computer to perform the algorithm described with reference to the drawings. The program(s) contains a set of instructions (or software codes) that, when loaded into a computer, causes the computer to perform one or more of the functions described in the example embodiments. The program(s) may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. The program(s) may be transmitted on a transitory computer readable medium or a communication medium. By way of example, and not limitation, transitory computer readable media or communication media can include electrical, optical, acoustical, or other form of propagated signals.

The above-described example embodiments are merely examples of the application of the technical ideas obtained by the inventors. These technical ideas are not limited to the above-described example embodiments and various modifications can be made thereto.

For example, the whole or part of the example embodiments disclosed above can be described as, but not limited to, the following supplementary notes.

### (Supplementary Note 1)

A first Radio Access Network (RAN) Intelligent Controller (RIC) comprising:
at least one memory; and
at least one processor coupled to the at least one memory and configured to:
   receive, in a single message, from a second RIC located between the first RIC and one or more RAN nodes, feedback regarding an enforcement status of a plurality of policies, each including one or more policy statements.

### (Supplementary Note 2)

The first RIC according to Supplementary Note 1, wherein the plurality of policies is any plurality of policies that the first RIC has requested the second RIC to create or set up.

### (Supplementary Note 3)

The first RIC according to Supplementary Note 1, wherein the plurality of policies each have a same scope identifier,
wherein the scope identifier represents a target to which one or more policy statements of the corresponding policy are applied.

### (Supplementary Note 4)

The first RIC according to Supplementary Note 1, wherein a scope identifier in each of the plurality of policies includes at least one common identifier,
wherein the scope identifier represents a target to which one or more policy statements of the corresponding policy are applied.

### (Supplementary Note 5)

The first RIC according to Supplementary Note 1, wherein the plurality of policies each contain a same set of one or more policy statements.

### (Supplementary Note 6)

The first RIC according to Supplementary Note 1, wherein a set of policy statements in each of the plurality of policies includes at least one common policy statement.

### (Supplementary Note 7)

The first RIC according to Supplementary Note 1, wherein the plurality of policies are policies that have been indicated by the first RIC to be associated with each other during policy creation.

### (Supplementary Note 8)

The first RIC according to any one of Supplementary Notes 1 to 7, wherein the at least one processor is configured to explicitly or implicitly indicate to the second RIC, during creation of the plurality of policies, that the plurality of policies are associable with each other for feedback.

### (Supplementary Note 9)

The first RIC according to Supplementary Note 8, wherein the at least one processor is configured to create or set up the plurality of policies in a single Hypertext Transfer Protocol (HTTP) transaction with the second RIC.

### (Supplementary Note 10)

The first RIC according to Supplementary Note 8, wherein the at least one processor is configured to indicate a same policy group identifier to the second RIC in a plurality of HTTP transactions to create the plurality of policies.

### (Supplementary Note 11)

The first RIC according to Supplementary Note 8, wherein the at least one processor is configured to indicate a same callback Uniform Resource Identifier (URI) or a same Notification Destination to the second RIC in a plurality of HTTP transactions to create the plurality of policies.

### (Supplementary Note 12)

The first RIC according to any one of Supplementary Notes 1 to 11, wherein the single message includes a plurality of scope identifiers, each of which is included in a corresponding one of the plurality of policies, wherein the scope identifier represents a target to which one or more policy statements of the corresponding policy are applied.

### (Supplementary Note 13)

The first RIC according to any one of Supplementary Notes 1 to 11, wherein the single message includes a plurality of policy identifiers, each indicating a respective one of the plurality of policies.

### (Supplementary Note 14)

The first RIC according to any one of Supplementary Notes 1 to 11, wherein the single message includes a plurality of identifiers, each associated with a respective one of the plurality of policies.

### (Supplementary Note 15)

The first RIC according to any one of Supplementary Notes 1 to 14, wherein the single message is configured to provide details regarding a cause of non-enforcement of at least one policy in the plurality of policies,
wherein the details regarding the cause of non-enforcement of the at least one policy indicate (a) a changed new value of at least one identifier included in a scope identifier associated with the at least one policy, (b) a reason why one or more policy statements of the at least one policy are inapplicable, or a combination thereof.

### (Supplementary Note 16)

The first RIC according to Supplementary Note 15, wherein the single message is a Hypertext Transfer Protocol (HTTP) POST request message,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the at least one policy.

### (Supplementary Note 17)

A method performed by a first Radio Access Network (RAN) Intelligent Controller (RIC), the method comprising:
receiving, in a single message, from a second RIC located between the first RIC and one or more RAN nodes, feedback regarding an enforcement status of a plurality of policies, each including one or more policy statements.

### (Supplementary Note 18)

A program for causing a computer to perform a method for a first Radio Access Network (RAN) Intelligent Controller (RIC), the method comprising:

receiving, in a single message, from a second RIC located between the first RIC and one or more RAN nodes, feedback regarding an enforcement status of a plurality of policies, each including one or more policy statements.

### (Supplementary Note 19)

A second Radio Access Network (RAN) Intelligent Controller (RIC) to be deployed between a first RIC and one or more RAN nodes, the second RIC comprising:
at least one memory; and
at least one processor coupled to the at least one memory and configured to:
   send, in a single message to the first RIC, feedback regarding an enforcement status of a plurality of policies, each including one or more policy statements.

### (Supplementary Note 20)

The second RIC according to Supplementary Note 19, wherein the plurality of policies is any plurality of policies that the first RIC has requested the second RIC to create or set up.

### (Supplementary Note 21)

The second RIC according to Supplementary Note 19, wherein the plurality of policies each have a same scope identifier,
wherein the scope identifier represents a target to which one or more policy statements of the corresponding policy are applied.

### (Supplementary Note 22)

The second RIC according to Supplementary Note 19, wherein a scope identifier in each of the plurality of policies includes at least one common identifier,
wherein the scope identifier represents a target to which one or more policy statements of the corresponding policy are applied.

### (Supplementary Note 23)

The second RIC according to Supplementary Note 19, wherein the plurality of policies each contain a same set of one or more policy statements.

### (Supplementary Note 24)

The second RIC according to Supplementary Note 19, wherein a set of policy statements in each of the plurality of policies includes at least one common policy statement.

### (Supplementary Note 25)

The second RIC according to Supplementary Note 19, wherein the plurality of policies are policies that have been indicated by the first RIC to be associated with each other during policy creation.

### (Supplementary Note 26)

The second RIC according to any one of Supplementary Notes 19 to 25, wherein the at least one processor is configured to be explicitly or implicitly indicated by the first RIC, during creation of the plurality of policies, that the plurality of policies are associable with each other for feedback.

### (Supplementary Note 27)

The second RIC according to Supplementary Note 26, wherein the at least one processor is configured to receive a request to create or set up the plurality of policies in a single Hypertext Transfer Protocol (HTTP) transaction with the first RIC.

### (Supplementary Note 28)

The second RIC according to Supplementary Note 26, wherein the at least one processor is configured to receive a same policy group identifier from the first RIC in a plurality of HTTP transactions to create the plurality of policies.

### (Supplementary Note 29)

The second RIC according to Supplementary Note 26, wherein the at least one processor is configured to receive a same callback Uniform Resource Identifier (URI) or a same Notification Destination from the first RIC in a plurality of HTTP transactions to create the plurality of policies.

### (Supplementary Note 30)

The second RIC according to any one of Supplementary Notes 19 to 29, wherein the single message includes a plurality of scope identifiers, each of which is included in a corresponding one of the plurality of policies,
wherein the scope identifier represents a target to which one or more policy statements of the corresponding policy are applied.

### (Supplementary Note 31)

The second RIC according to any one of Supplementary Notes 19 to 29, wherein the single message includes a plurality of policy identifiers, each indicating a respective one of the plurality of policies.

### (Supplementary Note 32)

The second RIC according to any one of Supplementary Notes 19 to 29, wherein the single message includes a plurality of identifiers, each associated with a respective one of the plurality of policies.

### (Supplementary Note 33)

The second RIC according to any one of Supplementary Notes 19 to 32, wherein the single message is configured to provide details regarding a cause of non-enforcement of at least one policy in the plurality of policies,
wherein the details regarding the cause of non-enforcement of the at least one policy indicate (a) a changed new value of at least one identifier included in a scope identifier associated with the at least one policy, (b) a reason why one or more policy statements of the at least one policy are inapplicable, or a combination thereof.

### (Supplementary Note 34)

The second RIC according to Supplementary Note 33, wherein the single message is a Hypertext Transfer Protocol (HTTP) POST request message,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the at least one policy.

### (Supplementary Note 35)

A method performed by a second Radio Access Network (RAN) Intelligent Controller (RIC) to be deployed between a first RIC and one or more RAN nodes, the method comprising:
sending, in a single message to the first RIC, feedback regarding an enforcement status of a plurality of policies, each including one or more policy statements.

### (Supplementary Note 36)

A program for causing a computer to perform a method for a second Radio Access Network (RAN) Intelligent Controller (RIC) to be deployed between a first RIC and one or more RAN nodes, the method comprising:
sending, in a single message to the first RIC, feedback regarding an enforcement status of a plurality of policies, each including one or more policy statements.

### (Supplementary Note 37)

A first Radio Access Network (RAN) Intelligent Controller (RIC) comprising:
at least one memory; and
at least one processor coupled to the at least one memory and configured to:
   send, in a single request message, to a second RIC located between the first RIC and one or more RAN nodes, a request to create a plurality of policies, each including one or more policy statements.

### (Supplementary Note 38)

The first RIC according to Supplementary Note 37, wherein the plurality of policies is any plurality of policies determined by the first RIC.

s(Supplementary Note 39)

The first RIC according to Supplementary Note 37, wherein the plurality of policies each have a same scope identifier,
wherein the scope identifier represents a target to which one or more policy statements of the corresponding policy are applied.

### (Supplementary Note 40)

The first RIC according to Supplementary Note 37, wherein a scope identifier in each of the plurality of policies includes at least one common identifier,
wherein the scope identifier represents a target to which one or more policy statements of the corresponding policy are applied.

### (Supplementary Note 41)

The first RIC according to Supplementary Note 37, wherein a set of policy statements in each of the plurality of policies includes at least one common policy statement.

### (Supplementary Note 42)

The first RIC according to any one of Supplementary Notes 37 to 41, wherein the at least one processor is configured to include in the single request message a plurality of scope identifiers, each of which is included in a corresponding one of the plurality of policies,
wherein the scope identifier represents a target to which one or more policy statements of the corresponding policy are applied.

### (Supplementary Note 43)

The first RIC according to any one of Supplementary Notes 37 to 41, wherein the at least one processor is configured to include in the single request message an array of policy objects, each corresponding to a respective one of the plurality of policies, wherein each policy object includes a scope identifier and one or more policy statements, and the scope identifier represents a target to which the one or more policy statements are applied.

### (Supplementary Note 44)

The first RIC according to any one of Supplementary Notes 37 to 43, wherein the at least one processor is configured to include in the single request message a policy group identifier assigned to the plurality of policies.

### (Supplementary Note 45)

The first RIC according to Supplementary Note 44, wherein
the single request message is a Hypertext Transfer Protocol (HTTP) PUT request message, and
the at least one processor is configured to:
   set a Uniform Resource Identifier (URI) containing the policy group identifier in a request line of the HTTP PUT request message; and
   include a plurality of policy identifiers, each indicating a respective one of the plurality of said policies, in a message body of the HTTP PUT request message.

### (Supplementary Note 46)

The first RIC according to any one of Supplementary Notes 37 to 45, wherein the single request message causes the second RIC to send feedback regarding an enforcement status of the plurality of policies to the first RIC in a single feedback message.

### (Supplementary Note 47)

The first RIC according to any one of Supplementary Notes 37 to 46, wherein the at least one processor is configured to instruct the second RIC in the single request message whether feedback regarding an enforcement status of the plurality of policies should be sent to the first RIC in a single feedback message or in a plurality of individual feedback messages.

### (Supplementary Note 48)

A method performed by a first Radio Access Network (RAN) Intelligent Controller (RIC), the method comprising:
sending, in a single request message, to a second RIC located between the first RIC and one or more RAN nodes, a request to create a plurality of policies, each including one or more policy statements.

### (Supplementary Note 49)

A program for causing a computer to perform a method for a first Radio Access Network (RAN) Intelligent Controller (RIC), the method comprising:
sending, in a single request message, to a second RIC located between the first RIC and one or more RAN nodes, a request to create a plurality of policies, each including one or more policy statements.

### (Supplementary Note 50)

A second Radio Access Network (RAN) Intelligent Controller (RIC) to be deployed between a first RIC and one or more RAN nodes, the second RIC comprising:
at least one memory; and
at least one processor coupled to the at least one memory and configured to:
   receive, in a single request message from the first RIC, a request to create a plurality of policies, each including one or more policy statements.

### (Supplementary Note 51)

The second RIC according to Supplementary Note 50, wherein the plurality of policies is any plurality of policies determined by the first RIC.

### (Supplementary Note 52)

The second RIC according to Supplementary Note 50, wherein the plurality of policies each have a same scope identifier,
wherein the scope identifier represents a target to which one or more policy statements of the corresponding policy are applied. (Supplementary Note 53)

The second RIC according to Supplementary Note 50, wherein a scope identifier in each of the plurality of policies includes at least one common identifier,
wherein the scope identifier represents a target to which one or more policy statements of the corresponding policy are applied.

### (Supplementary Note 54)

The second RIC according to Supplementary Note 50, wherein a set of policy statements in each of the plurality of policies includes at least one common policy statement.

### (Supplementary Note 55)

The second RIC according to any one of Supplementary Notes 50 to 54, wherein the single request message includes a plurality of scope identifiers, each of which is included in a corresponding one of the plurality of policies,
wherein the scope identifier represents a target to which one or more policy statements of the corresponding policy are applied.

### (Supplementary Note 56)

The second RIC according to any one of Supplementary Notes 50 to 54, wherein the single request message includes an array of policy objects, each corresponding to a respective one of the plurality of policies, wherein
each policy object includes a scope identifier and one or more policy statements, and
the scope identifier represents a target to which the one or more policy statements are applied.

### (Supplementary Note 57)

The second RIC according to any one of Supplementary Notes 50 to 56, wherein the single request message includes a policy group identifier assigned to the plurality of policies.

### (Supplementary Note 58)

The second RIC according to Supplementary Note 57, wherein
the single request message is a Hypertext Transfer Protocol (HTTP) PUT request message, wherein
a request line of the HTTP PUT request message specifies a Uniform Resource Identifier (URI) containing the policy group identifier, and
a message body of the HTTP PUT request message includes a plurality of policy identifiers, each indicating a respective one of the plurality of said policies.

### (Supplementary Note 59)

The second RIC according to any one of Supplementary Notes 50 to 58, wherein the at least one processor is configured to send feedback regarding an enforcement status of the plurality of policies to the first RIC in a single feedback message.

### (Supplementary Note 60)

The second RIC according to any one of Supplementary Notes 50 to 59, wherein the at least one processor is configured to determine, based on a content of the single request message, whether feedback regarding an enforcement status of the plurality of policies should be sent to the first RIC in a single feedback message or in a plurality of individual feedback messages.

### (Supplementary Note 61)

A method performed by a second Radio Access Network (RAN) Intelligent Controller (RIC) to be deployed between a first RIC and one or more RAN nodes, the method comprising:
receiving, in a single request message from the first RIC, a request to create a plurality of policies, each including one or more policy statements.

### (Supplementary Note 62)

A program for causing a computer to perform a method for a second Radio Access Network (RAN) Intelligent Controller (RIC) to be deployed between a first RIC and one or more RAN nodes, the method comprising:

receiving, in a single request message from the first RIC, a request to create a plurality of policies, each including one or more policy statements.

### (Supplementary Note 63)

A first Radio Access Network (RAN) Intelligent Controller (RIC) comprising:
at least one memory; and
at least one processor coupled to the at least one memory and configured to:
   receive, over an A1 interface, details regarding a cause of non-enforcement of an A1 policy from a second RIC located between the first RIC and one or more RAN nodes,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

### (Supplementary Note 64)

The first RIC according to Supplementary Note 63, wherein the at least one processor is configured to receive the details regarding the cause of non-enforcement of the A1 policy from the second RIC in an enhanced feedback policy procedure.

s(Supplementary Note 65)

The first RIC according to Supplementary Note 64, wherein the at least one processor is configured to receive a Hypertext Transfer Protocol (HTTP) POST request message from the second RIC in the enhanced feedback policy procedure,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the A1 policy.

### (Supplementary Note 66)

The first RIC according to Supplementary Note 63, wherein the at least one processor is configured to receive the details regarding the cause of non-enforcement of the A1 policy from the second RIC in an enhanced Query Policy Status procedure.

### (Supplementary Note 67)

The first RIC according to Supplementary Note 66, wherein the at least one processor is configured to receive a Hypertext Transfer Protocol (HTTP) GET response message from the second RIC in the enhanced Query Policy Status procedure,
wherein the HTTP GET response message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the A1 policy.

### (Supplementary Note 68)

The first RIC according to Supplementary Note 63, wherein the at least one processor is configured to receive the details regarding the cause of non-enforcement of the A1 policy from the second RIC in a new A1 policy procedure that is different from a feedback policy procedure and a Query Policy Status procedure.

### (Supplementary Note 69)

The first RIC according to Supplementary Note 68, wherein the new A1 policy procedure includes the first RIC receiving from the second RIC an HTTP POST request message indicating the details regarding the cause of non-enforcement of the A1 policy.

### (Supplementary Note 70)

The first RIC according to Supplementary Note 68, wherein the new A1 policy procedure includes the first RIC receiving from the second RIC an HTTP GET response message indicating the details regarding the cause of non-enforcement of the A1 policy.

### (Supplementary Note 71)

The first RIC according to any one of Supplementary Notes 63 to 70, wherein
the first RIC is an Open Radio Access Network (O-RAN) Non-Real-Time (Non-RT) RIC, and
the second RIC is an O-RAN Near-Real-Time (Near-RT) RIC.

### (Supplementary Note 72)

A method performed by a first Radio Access Network (RAN) Intelligent Controller (RIC), the method comprising:
receiving, over an A1 interface, details regarding a cause of non-enforcement of an A1 policy from a second RIC located between the first RIC and one or more RAN nodes,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

### (Supplementary Note 73)

A program for causing a computer to perform a method for a first Radio Access Network (RAN) Intelligent Controller (RIC), the method comprising:
receiving, over an A1 interface, details regarding a cause of non-enforcement of an A1 policy from a second RIC located between the first RIC and one or more RAN nodes,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

### (Supplementary Note 74)

A second Radio Access Network (RAN) Intelligent Controller (RIC) to be deployed between a first RIC and one or more RAN nodes, the second RIC comprising:
at least one memory; and
at least one processor coupled to the at least one memory and configured to:
   send details regarding a cause of non-enforcement of an A1 policy to the first RIC over an A1 interface,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

### (Supplementary Note 75)

The second RIC according to Supplementary Note 74, wherein the at least one processor is configured to send the details regarding the cause of non-enforcement of the A1 policy to the first RIC in an enhanced feedback policy procedure.

### (Supplementary Note 76)

The second RIC according to Supplementary Note 75, wherein the at least one processor is configured to send a Hypertext Transfer Protocol (HTTP) POST request message to the first RIC in the enhanced feedback policy procedure,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the A1 policy.

### (Supplementary Note 77)

The second RIC according to Supplementary Note 74, wherein the at least one processor is configured to send the details regarding the cause of non-enforcement of the A1 policy to the first RIC in an enhanced Query Policy Status procedure.

### (Supplementary Note 78)

The second RIC according to Supplementary Note 77, wherein the at least one processor is configured to send a Hypertext Transfer Protocol (HTTP) GET response message to the first RIC in the enhanced Query Policy Status procedure,
wherein the HTTP GET response message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the A1 policy.

### (Supplementary Note 79)

The second RIC according to Supplementary Note 74, wherein the at least one processor is configured to send the details regarding the cause of non-enforcement of the A1 policy to the first RIC in a new A1 policy procedure that is different from a feedback policy procedure and a Query Policy Status procedure.

### (Supplementary Note 80)

The second RIC according to Supplementary Note 79, wherein the new A1 policy procedure includes the second RIC sending to the first RIC an HTTP POST request message indicating the details regarding the cause of non-enforcement of the A1 policy.

### (Supplementary Note 81)

The second RIC according to Supplementary Note 79, wherein the new A1 policy procedure includes the second RIC sending to the first RIC an HTTP GET response message indicating the details regarding the cause of non-enforcement of the A1 policy.

### (Supplementary Note 82)

The second RIC according to any one of Supplementary Notes 74 to 81, wherein
the first RIC is an Open Radio Access Network (O-RAN) Non-Real-Time (Non-RT) RIC, and
the second RIC is an O-RAN Near-Real-Time (Near-RT) RIC.

### (Supplementary Note 83)

A method performed by a second Radio Access Network (RAN) Intelligent Controller (RIC) to be deployed between a first RIC and one or more RAN nodes, the method comprising:

sending details regarding a cause of non-enforcement of an A1 policy to the first RIC over an A1 interface,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

### (Supplementary Note 84)

A program for causing a computer to perform a method for a second Radio Access Network (RAN) Intelligent Controller (RIC) to be deployed between a first RIC and one or more RAN nodes, the method comprising:
sending details regarding a cause of non-enforcement of an A1 policy to the first RIC over an A1 interface,
wherein the details regarding the cause of non-enforcement of the A1 policy indicate (a) a changed new value of at least one identifier included in a scope identifier associated with the A1 policy, (b) a reason why one or more policy statements of the A1 policy are inapplicable, or a combination thereof.

This application is based upon and claims the benefit of priority from Japanese Patent Application No. 2022-128678, filed on Aug. 12, 2022, the disclosure of which is incorporated herein in its entirety by reference.

### REFERENCE SIGNS LIST

1 Non-RT RIC
2 SMO framework
3 Near-RT RIC
4 E2 Node
2210 Processor
2220 Memory
2230 Mass storage

What is claimed is:

1-16. (canceled)

17. A method performed by a first Radio Access Network (RAN) Intelligent Controller (RIC), the method comprising:
receiving, in a single message, from a second RIC located between the first RIC and one or more RAN nodes, feedback regarding an enforcement status of a plurality of policies, each including one or more policy statements.

18. (canceled)

19. A second Radio Access Network (RAN) Intelligent Controller (RIC) to be deployed between a first RIC and one or more RAN nodes, the second RIC comprising:
at least one memory; and
at least one processor coupled to the at least one memory and configured to:
send, in a single message to the first RIC, feedback regarding an enforcement status of a plurality of policies, each including one or more policy statements.

20-34. (canceled)

35. A method performed by a second Radio Access Network (RAN) Intelligent Controller (RIC) to be deployed between a first RIC and one or more RAN nodes, the method comprising:
sending, in a single message to the first RIC, feedback regarding an enforcement status of a plurality of policies, each including one or more policy statements.

36-38 . (canceled)

85. The method according to claim 17, wherein the plurality of policies is any plurality of policies that the first RIC has requested the second RIC to create or set up.

86. The method according to claim 17, wherein the plurality of policies each have a same scope identifier,
wherein the scope identifier represents a target to which one or more policy statements of the corresponding policy are applied.

87. The method according to claim 17, further comprising creating or setting up the plurality of policies in a single Hypertext Transfer Protocol (HTTP) transaction with the second RIC.

88. The method according to claim 17, further comprising indicating a same policy group identifier to the second RIC in a plurality of HTTP transactions to create the plurality of policies.

89. The method according to claim 17, wherein the single message is configured to provide details regarding a cause of non-enforcement of at least one policy in the plurality of policies,
wherein the details regarding the cause of non-enforcement of the at least one policy indicate (a) a changed new value of at least one identifier included in a scope identifier associated with the at least one policy, (b) a reason why one or more policy statements of the at least one policy are inapplicable, or a combination thereof.

90. The method according to claim 89, wherein the single message is a Hypertext Transfer Protocol (HTTP) POST request message,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the at least one policy.

91. The method according to claim 35, wherein the plurality of policies is any plurality of policies that the first RIC has requested the second RIC to create or set up.

92. The method according to claim 35, wherein the plurality of policies each have a same scope identifier,
wherein the scope identifier represents a target to which one or more policy statements of the corresponding policy are applied.

93. The method according to claim 35, wherein a scope identifier in each of the plurality of policies includes at least one common identifier,
wherein the scope identifier represents a target to which one or more policy statements of the corresponding policy are applied.

94. The method according to claim 35, wherein the plurality of policies each contain a same set of one or more policy statements.

95. The method according to claim 35, wherein a set of policy statements in each of the plurality of policies includes at least one common policy statement.

96. The method according to claim 35, wherein the plurality of policies are policies that have been indicated by the first RIC to be associated with each other during policy creation.

97. The method according to claim 35, further comprising receiving a request to create or set up the plurality of policies in a single Hypertext Transfer Protocol (HTTP) transaction with the first RIC.

98. The method according to claim 35, further comprising receiving a same policy group identifier from the first RIC in a plurality of HTTP transactions to create the plurality of policies.

99. The method according to claim 35, wherein the single message includes a plurality of scope identifiers, each of which is included in a corresponding one of the plurality of policies,
wherein the scope identifier represents a target to which one or more policy statements of the corresponding policy are applied.

100. The method according to claim 35, wherein the single message is configured to provide details regarding a cause of non-enforcement of at least one policy in the plurality of policies,
wherein the details regarding the cause of non-enforcement of the at least one policy indicate (a) a changed new value of at least one identifier included in a scope identifier associated with the at least one policy, (b) a reason why one or more policy statements of the at least one policy are inapplicable, or a combination thereof.

101. The method according to claim 100, wherein the single message is a Hypertext Transfer Protocol (HTTP) POST request message,
wherein the HTTP POST request message includes an enforceStatus attribute indicating NOT_ENFORCED and an enforceReason attribute indicating SCOPE_NOT_APPLICABLE, STATEMENT_NOT_APPLICABLE, or OTHER_REASON, and further includes a new attribute indicating the details regarding the cause of non-enforcement of the at least one policy.
